(19) United States
(12) Patent Application Publication
(10) Pub. No.: US 2026/0259671 A1
(43) Pub. Date: Sep. 3, 2026

(54) SPACE BALANCING HEURISTICS TO FACILITATE TRANSFER OF OWNERSHIP OF ALLOCATION AREAS WITHIN A DISTRIBUTED STORAGE SYSTEM USING DISAGGREGATED STORAGE

(71) Applicant: NetApp, Inc., San Jose, CA (US)

(72) Inventors: Rupa Natarajan, Sunnyvale, CA (US); Wei Sun, Boulder, CO (US); Santhosh Selvaraj, San Jose, CA (US); Marshall Ronald Boser, Minneapolis, MN (US); Meera Odugoudar, Milpitas, CA (US)

(73) Assignee: NetApp, Inc., San Jose, CA (US)

(21) Appl. No.: 19/068,304

(22) Filed: Mar. 3, 2025

(51) Int. Cl. G06F 3/06

(52) U.S. Cl. CPC G06F 3/0631; G06F 3/0604; G06F 3/0635; G06F 3/067; G06F 3/0689

(57) ABSTRACT

Systems and methods for performing space balancing heuristics within a distributed storage system that makes use of disaggregated storage are provided. In various examples described herein, the unit of storage space assignment used to associate blocks of storage space within a storage pod with a given dynamically extensible file system (DEFS) is an AA, representing a large chunk of one or more gigabytes (GB). The use of AAs described herein allows disk space to be used more elastically across individual nodes of a storage cluster. Each DEFS periodically reports its AA usage information by persisting it to a respective heuristic block within the storage pod. An AA director operable within the cluster periodically monitors the reported AA usage information, performs a heuristic algorithm to determine donor and recipient DEFSs at a given instance, and triggers AA movement accordingly by matching one or more donor DEFSs to each recipient DEFS.

### CROSS-REFERENCE TO RELATED APPLICATIONS

This application is related to US Patent Application No. ___ (attorney docket number NTAP-P-012773-US2-CIP), filed on Jan. 31, 2024, which is hereby incorporated by reference in its entirety for all purposes.

### BACKGROUND

### Field

Various embodiments of the present disclosure generally relate to storage systems. In particular, some embodiments relate to the implementation and use of disaggregated storage space of a storage pod by a distributed storage system having a disaggregated storage architecture to, among other things, avoid silos of storage space associated with a given node of the cluster and allow storage space to be used more fluidly/elastically across all the individual storage systems (e.g., nodes) of the distributed storage system by monitoring storage space utilization and directing movement of allocation areas (AAs) among donor and recipient dynamically extensible file system (DEFSs) based on heuristic policies.

### Description of the Related Art

Distributed storage systems generally take the form of a cluster of storage controllers (or nodes in virtual or physical form). As a result of sub-optimal infrastructure architectures, prior scale-out storage solutions do not effectively utilize all three vectors of infrastructure (i.e., compute, network, and storage). For example, as shown in FIG. 5, each node of a distributed storage system may be associated with a dedicated pool of storage space (e.g., a node-level aggregate representing a file system that holds one or more volumes created over one or more Redundant Array of Independent Disks (RAID) groups and which is only accessible from a single node at a time), thereby creating storage silos.

### SUMMARY

Systems and methods are described for space balancing heuristics within a distributed storage system that makes use of disaggregated storage. According to one embodiment, a storage pod having a group of storage devices containing multiple Redundant Array of Independent Disks (RAID) groups is provided in which a global physical volume block number (PVBN) space associated with the storage pod is accessible to all nodes of multiple nodes of a cluster representing a distributed storage system via their respective dynamically extensible file systems (DEFSs). Storage space associated with the group of storage devices is partitioned into multiple allocation areas (AAs), in which a given AA of the multiple AAs is owned by a given DEFS of multiple DEFSs of the cluster. One or more storage space metrics are determined based on usage information relating to the multiple AAs reported by or on behalf of their respective owning DEFSs. Based on the usage information, a set of one or more donor DEFSs and a set of one or more recipient DEFSs from among the multiple DEFSs are identified. Space balancing may then be facilitated by matching at least one donor DEFS of the set of one or more donor DEFSs with a recipient DEFS of the set of one or more recipient DEFSs.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating a plurality of nodes interconnected as a cluster in accordance with an embodiment of the present disclosure.

FIG. 2 is a block diagram illustrating a node in accordance with an embodiment of the present disclosure.

FIG. 3 is a block diagram illustrating a storage operating system in accordance with an embodiment of the present disclosure.

FIG. 4 is a block diagram illustrating a tree of blocks representing of an example a file system layout in accordance with an embodiment of the present disclosure.

FIG. 5 is a block diagram illustrating a distributed storage system architecture in which the entirety of a given disk and a given RAID group are owned by an aggregate and the aggregate file system is only visible from one node, thereby resulting in silos of storage space.

FIG. 6A is a block diagram illustrating a distributed storage system architecture that provides disaggregated storage in accordance with an embodiment of the present disclosure.

FIG. 6B is a high-level flow diagram illustrating operations for establishing disaggregated storage within a storage pod in accordance with an embodiment of the present disclosure.

FIG. 7 is a sequence diagram illustrating operations performed by various functional units associated with space balancing in accordance with an embodiment of the present disclosure.

FIG. 8 is a flow diagram illustrating operations associated with space balancing that may be performed by an AA director in accordance with an embodiment of the present disclosure.

FIG. 9 is a flow diagram illustrating operations for performing a space balancing heuristic algorithm in accordance with an embodiment of the present disclosure.

FIG. 10 is a block diagram conceptually illustrating nodes of a high-availability (HA) cluster and relevant AA heuristic data maintained by the respective nodes and an AA director in accordance with an embodiment of the present disclosure.

FIG. 11 is a block diagram conceptually illustrating a global view of system information used to perform space balancing heuristics in accordance with an embodiment of the present disclosure.

FIG. 12A is a free space graph conceptually illustrating how space balancing operates during a normal mode in accordance an embodiment of the present disclosure.

FIG. 12B is a free space graph conceptually illustrating how space balancing operates during a low space mode in accordance an embodiment of the present disclosure.

### DETAILED DESCRIPTION

Systems and methods are described for space balancing heuristics within a distributed storage system that makes use of disaggregated storage. As compared to existing scale out storage solution architectures, various examples described herein facilitate various advantages, including, but not limited to, one or more of the following:
Simplified management
No silos of storage space
Independent file system operation on each node of a cluster
Independent scaling of performance and capacity (e.g., the ability to independently add nodes and/or disks on demand)
Reduced internode (or “East-West”) communications/traffic
No additional redirection in the Input/Output (I/O) path
No additional write amplification
Integration with existing storage operating systems (e.g., the ONTAP data management software available from NetApp, Inc. of San Jose, CA).
Distributed storage device operations
The ability to use all disks associated with a distributed storage system in a more uniform manner

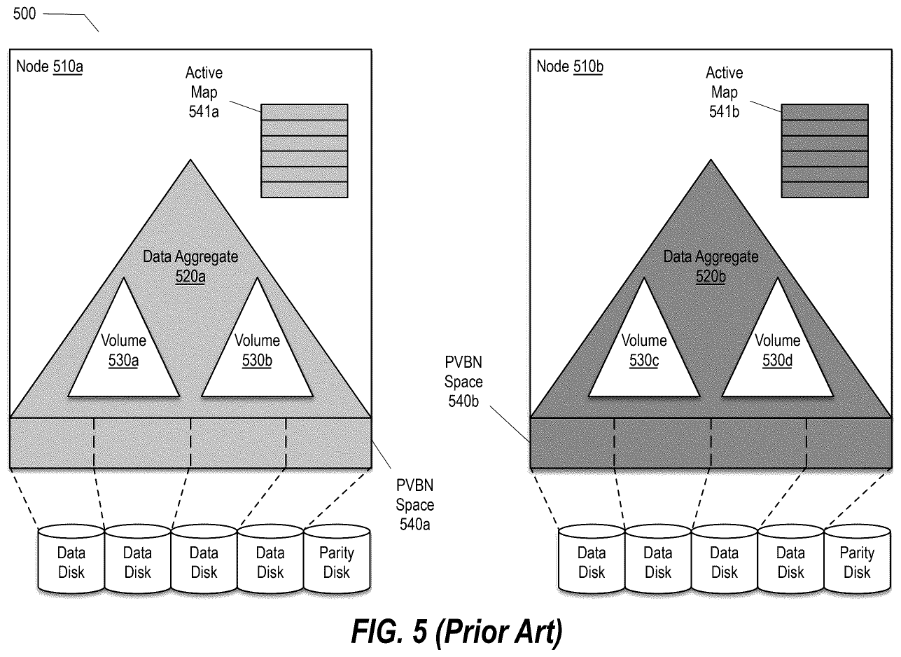

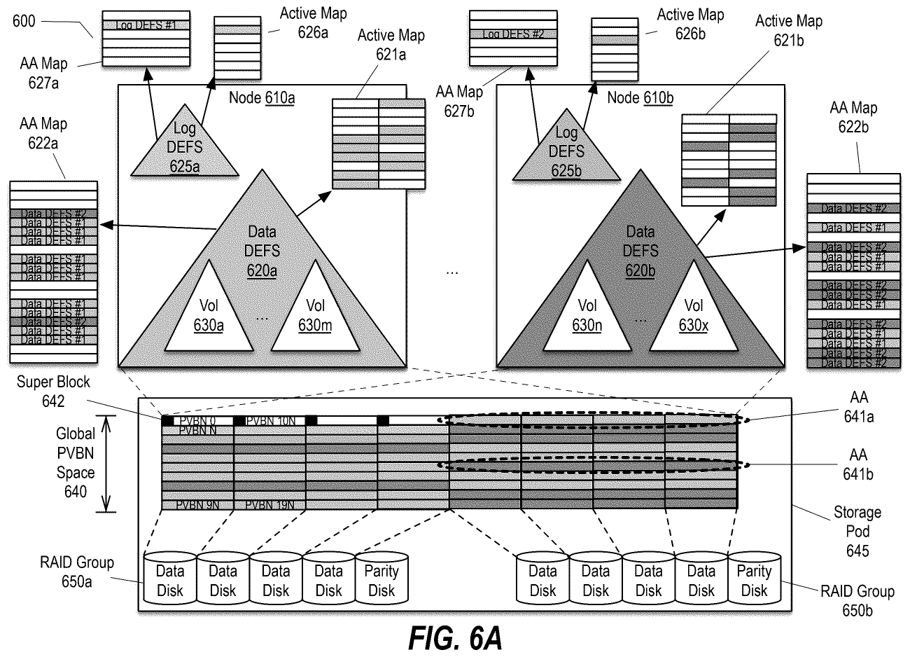

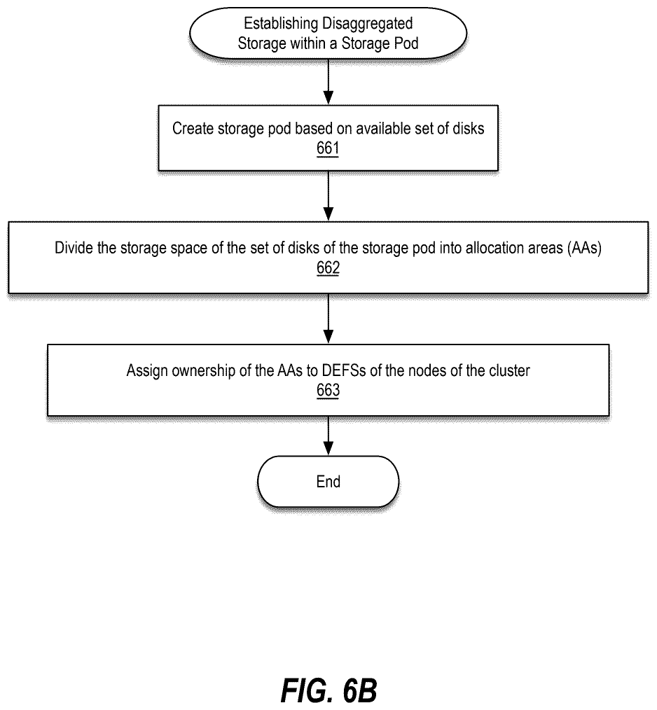

In various examples described herein, storage space may be used more fluidly across all the individual storage systems (e.g., nodes) of a distributed storage system (e.g., a cluster of nodes working together), thereby eliminating silos of storage; and processing resource (e.g., central processing unit (CPU)) load may be distributed across the cluster. The proposed architecture seeks to prevent a given storage device from being tied to any single node of the cluster by introducing a new construct referred to herein as a “dynamically extensible file system,” examples of which are described further below with reference to FIG. 6A. In contrast to the entirety of a given storage device (e.g., a “disk,” used interchangeably throughout this specification) being owned by a node-level aggregate and the aggregate file system being visible from only one node of a cluster as shown and described with reference to FIG. 5, the use of dynamically extensible file systems facilitates visibility by all nodes in the cluster to the entirety of a global physical volume block number (PVBN) space of the disks associated with a single “storage pod” (another new construct introduced herein) that may be shared by all of the nodes of the cluster with space from the global PVBN space being used on demand.

In one embodiment, each node of a cluster has access to do read and write to all the disks in a storage pod associated with a cluster. Given all the nodes have access to the same disks, a RAID subsystem or layer can now assimilate the same RAID tree from the same set of disks and present the global PVBN space to the file system (e.g., a write anywhere file system, such as the write anywhere file layout (WAFL) file system available from NetApp, Inc. of San Jose, CA). Using the global PVBN space, each node of the cluster can create an independent file system that it needs. As those skilled in the art will appreciate, it would be dangerous for each node to allocate from the same global PVBN space independently and without limitation. As such, examples of the proposed architecture restrict each dynamically extensible file system to use (consume) space only from the blocks assigned to it or “owned” by it. As such, when performing writes, each dynamically extensible file system stays in its own lane without the need for complex access control mechanisms, such as locks.

As described further below, in some examples, the association of blocks to a dynamically extensible file system may be in large chunks of one or more gigabytes (GB), which are referred to herein as “allocation areas” (AAs) that each include multiple RAID stripes. The use of large, multi-GB chunks, as the unit of space allocation/assignment to dynamically extensible file systems facilitates ease of management (e.g., by way of reducing the frequency of ownership transfers among dynamically extensible file systems) of these AAs. The assignment of AAs to individual dynamically extensible file systems, which in turn are owned by nodes, additionally helps each node do its write allocation independently since, by definition an entire RAID stripe is owned by a single dynamically extensible file system. In some embodiments, dynamically extensible file systems also minimize or at least significantly reduce the need for internode communications. For example, dynamically extensible file systems can limit their coordination across nodes to situations in which space balancing is to be performed (e.g., responsive to a node running low on free storage space relative to the other nodes), which is not a frequent operation. Responsive to a space balancing trigger event, a given dynamically extensible file system (or the node owning given dynamically extensible file system on behalf of the given dynamically extensible file system) may request space be reassigned to it from one or more other dynamically extensible file systems. The combination of visibility into the entire global PVBN space and the use of dynamically extensible file systems and their association with a given portion of the disaggregated storage of a storage pod to which a given dynamically extensible file system has exclusive write access enables each node to run independently most of the time.

As described further below, in one embodiment, each DEFS of a storage cluster periodically reports its AA usage information (which may also be referred to herein as heuristics information) by persisting it to a respective heuristic block within the storage pod. An AA director operable within the cluster periodically monitors the reported AA usage information, performs a heuristic algorithm to determine donor and recipient DEFSs at a given instance, and triggers AA movement accordingly by matching one or more donor DEFSs to each recipient DEFS.

While in the context of various examples described herein, a storage cluster may be shown and described as having a single high-availability (HA) pair of nodes, it is to be appreciated in other examples a storage cluster may include multiple (e.g., 5, 10, 16, 32, etc.) HA pairs. Similarly, while in the context of various examples described herein, a space balancing heuristics policy may be based on free space balancing (e.g., in which the goal is to balance free storage space among those DEFSs participating in space balancing and bring each DEFS toward the average free space), in other examples the space balancing heuristics policy may be based on used space balancing.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

The terms “component”, “module”, “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The term file/files as used herein include data container/data containers, directory/directories, and/or data object/data objects with structured or unstructured data.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (Saas), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system (e.g., a node), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein. In some embodiments, a light-weight data adaptor may be deployed on one or more server or compute nodes added to a cluster to allow compute-intensive data services to be performed without adversely impacting performance of storage operations being performed by other nodes of the cluster. The light-weight data adaptor may be created based on a storage operating system but, since the server node will not participate in handling storage operations on behalf of clients, the light-weight data adaptor may exclude various subsystems/modules that are used solely for serving storage requests and that are unnecessary for performance of data services. In this manner, compute intensive data services may be handled within the cluster by one of more dedicated compute nodes.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein a “consistency point” or “CP” generally refers to the act of writing data to disk and updating active file system pointers. In various examples, when a file system of a storage system receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. Virtual storage appliances may use NV storage backed by cloud volumes in place of NVRAM for journaling storage and for the buffer cache. Regardless of whether NVRAM or NV storage is utilized, the modified data may be periodically (e.g., every few seconds) flushed to the data storage media. As the buffer cache may be limited in size, an additional cache level may be provided by a victim cache, typically implemented within a slower memory or storage device than utilized by the buffer cache, that stores data evicted from the buffer cache. The event of saving the modified data to the mass storage devices may be referred to as a CP. At a CP, the file system may save any data that was modified by write requests to persistent data storage media. As will be appreciated, when using a buffer cache, there is a small risk of a system failure occurring between CPs, causing the loss of data modified after the last CP. Consequently, the storage system may maintain an operation log or journal of certain storage operations within the journaling storage media that have been performed since the last CP. This log may include a separate journal entry (e.g., including an operation header) for each storage request received from a client that results in a modification to the file system or data. Such entries for a given file may include, for example, “Create File,” “Write File Data,” and the like. Depending upon the operating mode or configuration of the storage system, each journal entry may also include the data to be written according to the corresponding request. The journal may be used in the event of a failure to recover data that would otherwise be lost. For example, in the event of a failure, it may be possible to replay the journal to reconstruct the current state of stored data just prior to the failure. As described further below, in various examples there may be one or more predefined or configurable triggers (CP triggers). Responsive to a given CP trigger (or at a CP), the file system may save any data that was modified by write requests to persistent data storage media.

As used herein, a “RAID stripe” generally refers to a set of blocks spread across multiple storage devices (e.g., disks of a disk array, disks of a disk shelf, or cloud volumes) to form a parity group (or RAID group, which may be abbreviated herein as RG).

As used herein, an “allocation area” or “AA” generally refers to a group of RAID stripes. In various examples described herein a single storage pod may be shared by a distributed storage system by assigning ownership of AAs to respective dynamically extensible file systems (DEFSs) of a storage system.

As used herein, “ownership” of an AA generally refers to the ability of the owning DEFS to use the AA space (e.g., the blocks associated with the AA) for performance of writes or write operations. In the context of various embodiments described herein, only one DEFS can write to a given block (PVBN) at a time for multiple correctness reasons, so it is the DEFS that owns the given AA of which the given block is associated that has the exclusive ability among all other DEFSs in the storage system to write to the given block. Further, in embodiments described herein, for the file system metadata to be correct, the file system metadata for a given AA is coordinated in one place.

As used herein, “space balancing” generally refers to the movement of one or more AAs from one DEFS (which may be referred to as a donor DEFS) to another DEFS (which may be referred to as a recipient DEFS) of a storage system; or stated another way changing of the ownership of one or more AA from the donor DEFS to the recipient DEFS. Space balancing may be performed to address a number of storage space-related issues including, but not limited to, balancing of (i) free space within DEFSs of a storage cluster, (ii) used space within the DEFSs, (iii) total owned space, and/or (iv) AA quality owned by the DEFSs.

As used herein, a “quality” of an AA generally refers to one of a multiple categories, buckets, bins, or enumerated types of AAs, for example, with respect to the level of usage of PVBNs associated with the AA. In one example, AAs may be categorized coarsely as (i) free AAs, (ii) partial AAs, and (iii) full AAs. In other examples, the partial AAs may be further refined by bucketing or binning the AAs in accordance with predetermined or configurable used space percentage ranges or bands (e.g., of 5, 10, 20, 25 percent) based on their respective PVBNs that are in use or free.

As used herein, a “free allocation area,” an “empty allocation area,” a “free AA,” or an “empty AA” generally refers to an AA in which no PVBNs of the AA are marked as used or in use (containing valid data), for example, by any active maps of a given dynamically extensible file system.

As used herein, a “partial allocation area” or “partial AA” generally refers to an AA in which one or more PVBNs of the AA are marked as used or in use (containing valid data), for example, by an active map of a given dynamically extensible file system. As discussed further below, in connection with space balancing, while it is preferable to perform AA ownership changes of free AAs, in various examples, space balancing may involve one dynamically extensible file system donating one or more partial AAs to another dynamically extensible file system. In such cases, the additional cost of transferring or copying all or portions of one or more associated metafiles or data structures (e.g., bit maps, such as an active map, a refcount map, a summary map, an AA information map, and a space map) relating to storage space information may be incurred. No such additional cost is incurred when moving or changing ownership of free AAs. These associated metafiles or data structures may, among other things, track which PVBNs are in use, track PVBN counts per AA (e.g., total used blocks and shared references to blocks) and other flags. In some examples, the metafiles associated with storage may be very large. As such, in order to reduce the size of a message (which may also be referred to as an *** AA package) transferred from the donor DEFS to the recipient DEFS for a given AA (or set of one or more AAs) being transferred to the recipient DEFS, various optimizations may be employed to avoid copying the entire content of a given metafile into the message. According to one embodiment, only the portion or part of the metafile corresponding to the storage that is being moved is transferred to the recipient DEFS. For example, as described further below, in accordance with a first optimization, one or more level-0 (L0) PVBNs pointing to respective data blocks containing metafile data for the given AA may be included in the message. In a second optimization, one or more level-1 (L1) PVBNs, which in turn each point to multiple L0 PVBNs, may be included in the message and those of the L0 PVBNs

As used herein, a “full allocation area” or “a full AA” generally refers to a partial AA for which a predetermined or configurable threshold of PVBNs of the partial AA are marked as used or in use (containing valid data). For example, a partial AA may be considered to be a full AA when 96% or more of its storage space is in use.

As used herein, a “storage pod” generally refers to a group of disks containing multiple RAID groups (RGs) that are accessible from all storage systems (nodes) of a distributed storage system (cluster).

As used herein, a “data pod” generally refers to a set of storage systems (nodes) that share the same storage pod. In some examples, a data pod refers to a single cluster of nodes representing a distributed storage system. In other examples, there can be multiple data pods in a cluster. Data pods may be used to limit the fault domain and there can be multiple HA pairs of nodes within a data pod.

As used herein, an “active map” is a metafile or data structure that contains file system metadata information indicative of which PVBNs of a distributed file system are in use. In one embodiment, the active map is represented in the form of a sparce bit map in which each PVBN of a global PVBN space of a storage pod has a corresponding Boolean value (or truth value) represented as a single bit, for example, in which the true (1) indicates the corresponding PVBN is in use and false (0) indicates the corresponding PVBN is not in use.

As used herein, a “dynamically extensible file system” or a “DEFS” generally refers to a file system of a data pod or a cluster that has visibility into the entire global PVBN space of a storage pod and hosts multiple volumes. A DEFS may be thought of as a data container or a storage container (which may be referred to as a storage segment container) to which AAs are assigned, thereby resulting in a more flexible and enhanced version of a node-level aggregate. As described further herein (for example, in connection with automatic space balancing), the storage space associated with one or more AAs of a given DEFS may be dynamically transferred or moved on demand to any other DEFS in the cluster by changing the ownership of the one or more AAs and moving associated AA tracking data structures as appropriate. This provides the unique ability to independently scale each DEFS of a cluster. For example, DEFSs can shrink or grow dynamically over time to meet their respective storage needs and silos of storage space are avoided. In one embodiment, a distributed file system comprises multiple instances of the WAFL Copy-on-Write file system running on respective storage systems (nodes) of a distributed storage system (cluster) that represents the data pod. In various examples described herein, a given storage system (node) of a distributed storage system (cluster) may own one or more DEFSs including, for example, a log DEFS for hosting an operation log or journal of certain storage operations that have been performed by the node since the last CP and a data DEFS for hosting customer volumes or logical unit numbers (LUNs). As described further below, the partitioning/division of a storage pod into AAs (creation of a disaggregated storage space) and the distribution of ownership of AAs among DEFSs of multiple nodes of a cluster may facilitate implementation of a distributed storage system having a disaggregated storage architecture. In various examples described herein, each storage system may have its own portion of disaggregated storage to which it has the exclusive ability to perform write access, thereby simplifying storage management by, among otherings, not requiring implementation of access control mechanisms, for example, in the form of locks. At the same time, each storage system also has visibility into the entirety of a global PVBN space, thereby allowing read access by a given storage system to any portion of the disaggregated storage regardless of which node of the cluster is the current owner of the underlying allocation areas. Based disclosure provided herein, those skilled in the art will understand there are at least two types of disaggregation represented/achieved within various examples, including (i) the disaggregation of storage space provided by a storage pod by dividing or partitioning the storage space into AAs the ownership of which can be fluidly changed from one DEFS to another on demand and (ii) the disaggregation of the storage architecture into independent components, including the decoupling of processing resources and storage resources, thereby allowing them to be independently scaled. In one embodiment, the former (which may also be referred to as modular storage, partitioned storage, adaptable storage, or fluid storage) facilitates the latter.

As used herein, an “allocation area map,” “AA map,” or “AA owner file” generally refers to a per dynamically extensible file system data structure or file (e.g., a metafile) that contains metadata information at an AA-level of granularity indicative of which AAs are assigned to or “owned” by a given dynamically extensible file system.

A “node-level aggregate” generally refers to a file system of a single storage system (node) that holds multiple volumes created over one or more RAID groups (RGs), in which the node owns the entire PVBN space of the collection of disks of the one or more RGs. Node-level aggregates are only accessible from a single storage system (node) of a distributed storage system (cluster) at a time.

As used herein, an “index node” or “inode” generally refers to a file data structure maintained by a file system that stores metadata for data containers (e.g., directories, subdirectories, disk files, etc.). An inode may include, among other things, location, file size, permissions needed to access a given file with which it is associated as well as creation, read, and write timestamps, and one or more flags.

As used herein, a “storage volume” or “volume” generally refers to a container in which applications, databases, and file systems store data. A volume is a logical component created for the host to access storage on a storage array. A volume may be created from the capacity available in storage pod, a pool, or a volume group. A volume has a defined capacity. Although a volume might consist of more than one drive, a volume appears as one logical component to the host. Non-limiting examples of a volume include a flexible volume and a flexgroup volume.

As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises an RG. Moreover, each RG may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP Flex Vol volume.

As used herein, a “flexgroup volume” generally refers to a single namespace that is made up of multiple constituent/member volumes. A non-limiting example of a flexgroup volume is a NetApp ONTAP FlexGroup volume that can be managed by storage administrators, and which acts like a NetApp Flex Vol volume. In the context of a flexgroup volume, “constituent volume” and “member volume” are interchangeable terms that refer to the underlying volumes (e.g., flexible volumes) that make up the flexgroup volume.

### Example Distributed Storage System Cluster

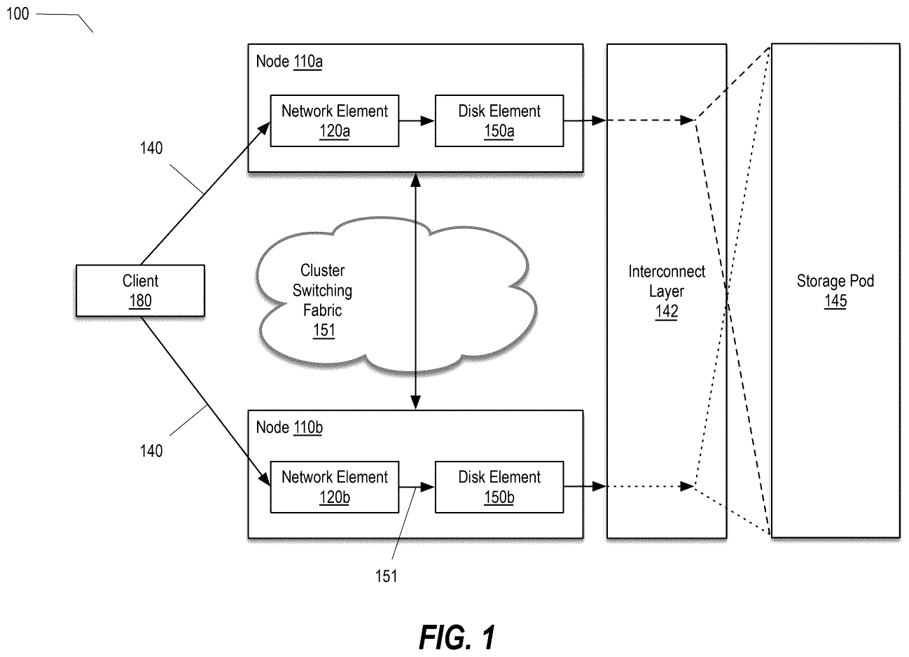

FIG. 1 is a block diagram illustrating a plurality of nodes 110a-b interconnected as a cluster 100 in accordance with an embodiment of the present disclosure. In the context of the present example, the nodes 110a-b comprise various functional components that cooperate to provide a distributed storage system architecture of the cluster 100. To that end, in the context of the present example, each node is generally organized as a network element (e.g., network element 120a or 120b) and a storage element (may also be referred to as a disk element, storage blade or disk blade) (e.g., disk element 150a or 150b). The network element includes functionality that enables the node to connect to clients (e.g., client 180) over a computer network 140, while each disk element 350 connects to one or more storage devices, such as disks, of one or more disk arrays (not shown) or of one or more storage shelves (not shown), represented as a single shared storage pod 145.

In the context of the present example, the nodes 110a-b are interconnected by a cluster switching fabric 151 which, in an example, may be embodied as a Gigabit Ethernet switch. It should be noted that while there is shown an equal number of network and disk elements in the illustrative cluster 100, there may be differing numbers of network and/or disk elements. For example, there may be a plurality of network elements and/or disk elements interconnected in a cluster configuration 100 that does not reflect a one-to-one correspondence between the network and disk elements. As such, the description of a node comprising one network element and one disk element should be taken as illustrative only.

Clients may be general-purpose computers configured to interact with the node in accordance with a client/server model of information delivery. That is, each client (e.g., client 180) may request the services of the node, and the node may return the results of the services requested by the client, by exchanging packets over the network 140. The client may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks. In various examples described herein, an administrative user (not shown) of the client may make use of a user interface (UI) presented by the cluster or a command line interface (CLI) of the cluster to, among other things, establish a data protection relationship between a source volume and a destination volume (e.g., a mirroring relationship specifying one or more policies associated with creation, retention, and transfer of snapshots), defining snapshot and/or backup policies, and association of snapshot policies with snapshots.

Disk elements 150a and 150b are illustratively connected to disks (not shown) within that may be organized into disk arrays within the storage pod 145. Alternatively, storage devices other than disks may be utilized, e.g., flash memory, optical storage, solid state devices, etc. As such, the description of disks should be taken as exemplary only.

In general, various embodiments envision a cluster (e.g., cluster 100) in which every node (e.g., nodes 110a-b) can essentially talk to every storage device (e.g., disk) in the storage pod 145. This is in contrast to the distributed storage system architecture described with reference to FIG. 5. In examples described herein, all nodes (e.g., nodes 110a-b) of the cluster have visibility and read access to an entirety of a global PVBN space of the storage pod 145, for example, via an interconnect layer 142. As described further below, according to one embodiment, the storage within the storage pod 145 is grouped into distinct allocation areas (AAs) than can be assigned to a given dynamically extensible file system (DEFS) of a node to facilitate implementation disaggregated storage. In examples described herein, the AAs assigned to a given DEFS may be said to “own” the assigned AAs and the node owning the given DEFS has the exclusive write access to the associated PVBNs and the exclusive ability to perform write allocation from such blocks. In one embodiment, each node has its own view of a portion of the disaggregated storage represented by the assignment of, for example, via respective allocation area (AA) maps and active maps. This granular assignment of AAs and ability to fluidly change ownership of AAs as needed facilitates the elimination of per-node storage silos and provides higher and more predictable performance, which further translate into improved storage utilization and improvements in cost effectiveness of the storage solution.

Depending on the particular implementation, the interconnect layer 142 may be represented by an intermediate switching topology or some other interconnectivity layer or disk switching layer between the disks in the storage pod 145 and the nodes. Non-limiting examples of the interconnect layer 150 include one or more fiber channel switches or one or more non-volatile memory express (NVMe) fabric switches. Additional details regarding the storage pod 145, DEFSs, AA maps, active maps, and the use, ownership, and sharing (transferring of ownership) of AAs are described further below.

### Example Storage System Node

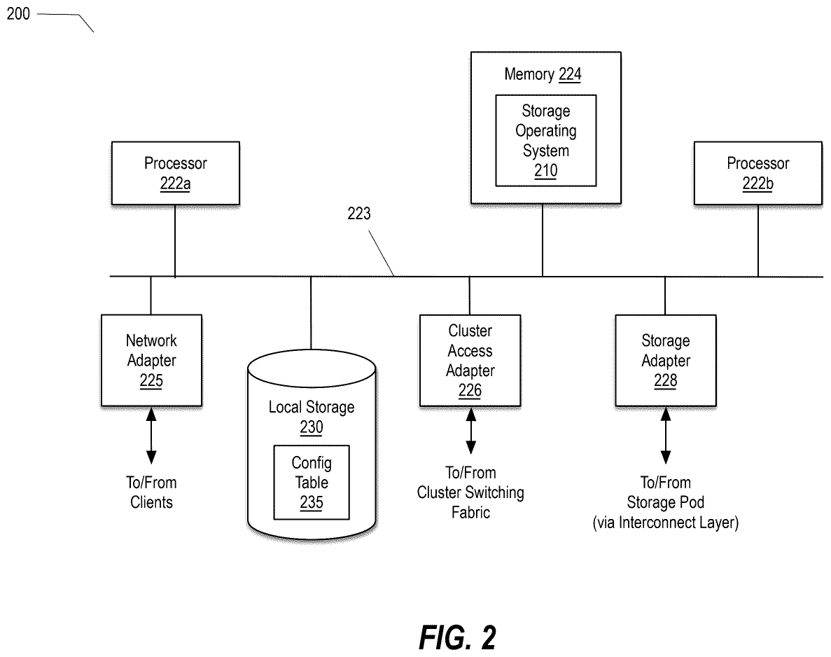

FIG. 2 is a block diagram of a node 200 that is illustratively embodied as a storage system comprising a plurality of processors (e.g., processors 222a-b), a memory 224, a network adapter 225, a cluster access adapter 226, a storage adapter 228 and local storage 230 interconnected by a system bus 223. Node 200 may be analogous to nodes 110a and 110b of FIG. 1. The local storage 230 comprises one or more storage devices, such as disks, utilized by the node to locally store configuration information (e.g., in configuration table 235). The cluster access adapter 226 comprises a plurality of ports adapted to couple the node 200 to other nodes of the cluster (e.g., cluster 100). Illustratively, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, the cluster access adapter 226 is utilized by the network and disk element for communicating with other network and disk elements in the cluster.

In the context of the present example, each node 200 is illustratively embodied as a dual processor storage system executing a storage operating system 210 that implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor (e.g., processor 222a) may execute the functions of the network element (e.g., network element 120a or 120b) on the node, while the other processor (e.g., processor 222b) may execute the functions of the disk element (e.g., disk element 150a or 150b).

The memory 224 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. The storage operating system 210, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the disclosure described herein.

The network adapter 225 comprises a plurality of ports adapted to couple the node 200 to one or more clients (e.g., client 180) over point-to-point links, wide area networks, virtual private networks implemented over a public network (Internet) or a shared local area network. The network adapter 225 thus may comprise the mechanical, electrical and signaling circuitry needed to connect the node to a network (e.g., computer network 140). Illustratively, the network may be embodied as an Ethernet network or a Fibre Channel (FC) network. Each client (e.g., client 180) may communicate with the node over network by exchanging discrete frames or packets of data according to pre-defined protocols, such as TCP/IP.

The storage adapter 228 cooperates with the storage operating system 210 executing on the node 200 to access information requested by the clients. The information may be stored on any type of attached array of writable storage device media such as video tape, optical, DVD, magnetic tape, bubble memory, electronic random access memory, micro-electromechanical and any other similar media adapted to store information, including data and parity information. However, as illustratively described herein, the information is stored on disks (e.g., associated with storage pod 145). The storage adapter comprises a plurality of ports having input/output (I/O) interface circuitry that couples to the disks over an I/O interconnect arrangement, such as a conventional high-performance, FC link topology.

Storage of information on each disk array may be implemented as one or more storage “volumes” that comprise a collection of physical storage disks or cloud volumes cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RG, and the appropriate storing of parity information with respect to the striped data. An illustrative example of a RAID implementation is a RAID-4 level implementation, although it should be understood that other types and levels of RAID implementations may be used in accordance with the inventive principles described herein.

While in the context of the present example, the node may be a physical host, it is to be appreciated the node may be implemented in virtual form. For example, a storage system may be run (e.g., on a VM or as a containerized instance, as the case may be) within a public cloud provider. As such, a cluster representing a distributed storage system may be comprised of multiple physical nodes (e.g., node 200) or multiple virtual nodes (virtual storage systems).

### Example Storage Operating System

To facilitate access to the disks (e.g., disks within one or more disk arrays of a storage pod, such as storage pod 145 of FIG. 1), a storage operating system (e.g., storage operating system 300, which may be analogous to storage operating system 210) may implement a write-anywhere file system that cooperates with one or more virtualization modules to “virtualize” the storage space provided by disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

Illustratively, the storage operating system may be the Data ONTAP operating system available from NetApp, Inc., San Jose, Calif. that implements the WAFL file system. However, it is expressly contemplated that any appropriate storage operating system may be enhanced for use in accordance with the inventive principles described herein. As such, where the term “WAFL” is employed, it should be taken broadly to refer to any file system that is otherwise adaptable to the teachings of this disclosure.

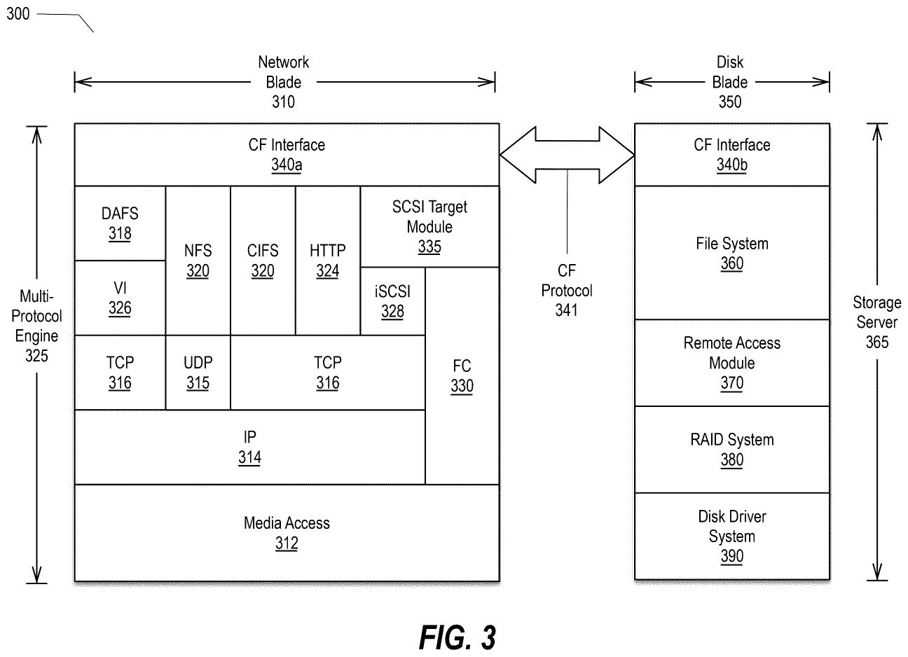

FIG. 3 is a block diagram illustrating a storage operating system 300 in accordance with an embodiment of the present disclosure. In the context of the present example, the storage operating system 300 is shown including a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 320, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 330 receives and transmits block access requests and responses to and from the node. The FC and iSCSI drivers provide FC-specific and iSCSI-specific access control to the blocks and, thus, manage exports of LUNs to either iSCSI or FCP or, alternatively, to both iSCSI and FCP when accessing the blocks on the node (e.g., node 200).

In addition, the storage operating system may include a series of software layers organized to form a storage server 365 that provides data paths for accessing information stored on the disks (e.g., disks 130) of the node. To that end, the storage server 365 includes a file system module 360 in cooperating relation with a remote access module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 may implement a virtualization system of the storage operating system 300 through the interaction with one or more virtualization modules illustratively embodied as, for example, a virtual disk (vdisk) module (not shown) and a SCSI target module 335. The SCSI target module 335 is generally disposed between the FC and iSCSI drivers 328, 330 and the file system 360 to provide a translation layer of the virtualization system between the block (LUN) space and the file system space, where LUNs are represented as blocks.

The file system 360 is illustratively a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 illustratively implements an exemplary a file system having an on-disk format representation that is block-based using, e.g., 4 kilobyte (KB) blocks and using index nodes (“inodes”) to identify files and file attributes (such as creation time, access permissions, size and block location). The file system uses files to store metadata describing the layout of its file system; these metadata files include, among others, an inode file. A file handle, i.e., an identifier that includes an inode number, is used to retrieve an inode from disk.

Broadly stated, all inodes of the write-anywhere file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., an RG. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from a client (e.g., client 180) is forwarded as a packet over a computer network (e.g., computer network 140) and onto a node (e.g., node 200) where it is received at a network adapter (e.g., network adaptor 225). A network driver (of layer 312 or layer 330) processes the packet and, if appropriate, passes it on to a network protocol and file access layer for additional processing prior to forwarding to the write-anywhere file system 360. Here, the file system generates operations to load (retrieve) the requested data from disk 130 if it is not resident “in core”, i.e., in memory 224. If the information is not in memory, the file system 360 indexes into the inode file using the inode number to access an appropriate entry and retrieve a logical VBN. The file system then passes a message structure including the logical VBN to the RAID system 380; the logical VBN is mapped to a disk identifier and disk block number (disk, dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

The remote access module 370 is operatively interfaced between the file system module 360 and the RAID system module 380. Remote access module 370 is illustratively configured as part of the file system to implement the functionality to determine whether a newly created data container, such as a subdirectory, should be stored locally or remotely. Alternatively, the remote access module 370 may be separate from the file system. As such, the description of the remote access module being part of the file system should be taken as exemplary only. Further, the remote access module 370 determines which remote flexible volume should store a new subdirectory if a determination is made that the subdirectory is to be stored remotely. More generally, the remote access module 370 implements the heuristics algorithms used for the adaptive data placement. However, it should be noted that the use of a remote access module should be taken as illustrative. In alternative aspects, the functionality may be integrated into the file system or other module of the storage operating system. As such, the description of the remote access module 370 performing certain functions should be taken as exemplary only.

It should be noted that the software “path” through the storage operating system layers described above needed to perform data storage access for the client request received at the node may alternatively be implemented in hardware. That is, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Alternatively, the processing elements of adapters 225, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node (e.g., node 200), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

In addition, it will be understood to those skilled in the art that aspects of the disclosure described herein may apply to any type of special-purpose (e.g., file server, filer or storage serving appliance) or general-purpose computer, including a standalone computer or portion thereof, embodied as or including a storage system. Moreover, the teachings contained herein can be adapted to a variety of storage system architectures including, but not limited to, a network-attached storage environment, a storage area network and disk assembly directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the subject matter may be utilized with any suitable file system, including a write in place file system.

### Example Cluster Fabric (CF) Protocol

Illustratively, the storage server 365 is embodied as disk element (or disk blade 350, which may be analogous to disk element 150a or 150b) of the storage operating system 300 to service one or more volumes of array 160. In addition, the multi-protocol engine 325 is embodied as network element (or network blade 310, which may be analogous to network element 120a or 120b) to (i) perform protocol termination with respect to a client issuing incoming data access request packets over the network (e.g., network 140), as well as (ii) redirect those data access requests to any storage server 365 of the cluster (e.g., cluster 100). Moreover, the network element 310 and disk element 350 cooperate to provide a highly scalable, distributed storage system architecture of the cluster. To that end, each module may include a cluster fabric (CF) interface module (e.g., CF interface 340a and 340b) adapted to implement intra-cluster communication among the nodes (e.g., node 110a and 110b). In the context of a distributed storage architecture as described below with reference to FIG. 5 in which node-level aggregates are employed, the CF protocol facilitates, among other things, internode communications relating to data access requests. It is to be appreciated such internode communications relating to data access requests are not needed in the context of a distributed storage architecture as described below with reference to FIG. 6A in which each node of a cluster has visibility and access to the entirety of a global PVBN space of a storage pod (via their respective DEFSs). However, in various embodiments, some limited amount of internode communications, for example, relating to storage space reporting (or simply space reporting) and storage space requests (e.g., requests for donations of AAs) continue to be useful. As described further below, such internode communications may make use of the CF protocol or other forms of internode communications, including message passing via on-wire communications and/or the use of one or more persistent message queues (or on-disk message queues), which may make use of the fact that all nodes can read from all disk of a storage pod. For example, a persistent message queue may be maintained at the node and/or DEFS-level of granularity in which each node and/or DEFS has a message queue to which others can post messages destined for the node or DEFS (as the case may be). In one embodiment, each DEFS has an associated inbound queue on which it receives messages sent by another DEFS in the cluster and an associated outbound queue on which it posts messages intended for delivery to another DEFS in the cluster

The protocol layers, e.g., the NFS/CIFS layers and the iSCSI/IFC layers, of the network element 310 may function as protocol servers that translate file-based and block based data access requests from clients into CF protocol messages used for communication with the disk element 350. That is, the network element servers may convert the incoming data access requests into file system primitive operations (commands) that are embedded within CF messages by the CF interface module 340 for transmission to the disk elements of the cluster.

Further, in an illustrative aspect of the disclosure, the network element and disk element are implemented as separately scheduled processes of storage operating system 300; however, in an alternate aspect, the modules may be implemented as pieces of code within a single operating system process. Communication between a network element and disk element may thus illustratively be effected through the use of message passing between the modules although, in the case of remote communication between a network element and disk element of different nodes, such message passing occurs over a cluster switching fabric (e.g., cluster switching fabric 151). A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc.

The CF interface module 340 implements the CF protocol for communicating file system commands among the nodes or modules of cluster. Communication may be illustratively effected by the disk element exposing the CF API to which a network element (or another disk element) issues calls. To that end, the CF interface module 340 may be organized as a CF encoder and CF decoder. The CF encoder of, e.g., CF interface 340a on network element 310 encapsulates a CF message as (i) a local procedure call (LPC) when communicating a file system command to a disk element 350 residing on the same node 200 or (ii) a remote procedure call (RPC) when communicating the command to a disk element residing on a remote node of the cluster 100. In either case, the CF decoder of CF interface 340b on disk element 350 de-encapsulates the CF message and processes the file system command.

Illustratively, the remote access module 370 may utilize CF messages to communicate with remote nodes to collect information relating to remote flexible volumes. A CF message is used for RPC communication over the switching fabric between remote modules of the cluster; however, it should be understood that the term “CF message” may be used generally to refer to LPC and RPC communication between modules of the cluster. The CF message includes a media access layer, an IP layer, a UDP layer, a reliable connection (RC) layer and a CF protocol layer. The CF protocol is a generic file system protocol that may convey file system commands related to operations contained within client requests to access data containers stored on the cluster; the CF protocol layer is that portion of a message that carries the file system commands. Illustratively, the CF protocol is datagram based and, as such, involves transmission of messages or “envelopes” in a reliable manner from a source (e.g., a network element 310) to a destination (e.g., a disk element 350). The RC layer implements a reliable transport protocol that is adapted to process such envelopes in accordance with a connectionless protocol, such as UDP.

### Example File System Layout

In one embodiment, a data container is represented in the write-anywhere file system as an inode data structure adapted for storage on the disks of a storage pod (e.g., storage pod 145). In such an embodiment, an inode includes a metadata section and a data section. The information stored in the metadata section of each inode describes the data container (e.g., a file, a snapshot, etc.) and, as such, includes the type (e.g., regular, directory, vdisk) of file, its size, time stamps (e.g., access and/or modification time) and ownership (e.g., user identifier (UID) and group ID (GID), of the file, and a generation number. The contents of the data section of each inode may be interpreted differently depending upon the type of file (inode) defined within the type field. For example, the data section of a directory inode includes metadata controlled by the file system, whereas the data section of a regular inode includes file system data. In this latter case, the data section includes a representation of the data associated with the file.

Specifically, the data section of a regular on-disk inode may include file system data or pointers, the latter referencing 4 KB data blocks on disk used to store the file system data. Each pointer is preferably a logical VBN to facilitate efficiency among the file system and the RAID system when accessing the data on disks. Given the restricted size (e.g., 128 bytes) of the inode, file system data having a size that is less than or equal to 64 bytes is represented, in its entirety, within the data section of that inode. However, if the length of the contents of the data container exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section of the inode (e.g., a second level inode) references an indirect block (e.g., a first level L1 block) that contains 224 pointers, each of which references a 4 KB data block on disk. For file system data having a size greater than 64 MB, each pointer in the data section of the inode (e.g., a third level L3 inode) references a double-indirect block (e.g., a second level L2 block) that contains 224 pointers, each referencing an indirect (e.g., a first level L1) block. The indirect block, in turn, which contains 224 pointers, each of which references a 4 kB data block on disk. When accessing a file, each block of the file may be loaded from disk into memory (e.g., memory 224). In other embodiments, higher levels are also possible that may be used to handle larger data container sizes.

When an on-disk inode (or block) is loaded from disk into memory, its corresponding in-core structure embeds the on-disk structure. The in-core structure is a block of memory that stores the on-disk structure plus additional information needed to manage data in the memory (but not on disk). The additional information may include, e.g., a “dirty” bit. After data in the inode (or block) is updated/modified as instructed by, e.g., a write operation, the modified data is marked “dirty” using the dirty bit so that the inode (block) can be subsequently “flushed” (stored) to disk.

According to one embodiment, a file in a file system comprises a buffer tree that provides an internal representation of blocks for a file loaded into memory and maintained by the write-anywhere file system 360. A root (top-level) buffer, such as the data section embedded in an inode, references indirect (e.g., level 1) blocks. In other embodiments, there may be additional levels of indirect blocks (e.g., level 2, level 3) depending upon the size of the file. The indirect blocks (e.g., and inode) includes pointers that ultimately reference data blocks used to store the actual data of the file. That is, the data of file are contained in data blocks and the locations of these blocks are stored in the indirect blocks of the file. Each level 1 indirect block may include pointers to as many as 224 data blocks. According to the “write anywhere” nature of the file system, these blocks may be located anywhere on the disks.

In one embodiment, a file system layout is provided that apportions an underlying physical volume into one or more virtual volumes (or flexible volumes) of a storage system, such as node 200. In such an embodiment, the underlying physical volume is an aggregate comprising one or more groups of disks, such as RGs, of the node. The aggregate has its own physical volume block number (PVBN) space and maintains metadata, such as block allocation structures, within that PVBN space. Each flexible volume has its own virtual volume block number (VVBN) space and maintains metadata, such as block allocation structures, within that VVBN space. Each flexible volume is a file system that is associated with a container file; the container file is a file in the aggregate that contains all blocks used by the flexible volume. Moreover, each flexible volume comprises data blocks and indirect blocks that contain block pointers that point at either other indirect blocks or data blocks.

In a further embodiment, PVBNs are used as block pointers within buffer trees of files stored in a flexible volume. This “hybrid” flexible volume example involves the insertion of only the PVBN in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following PVBNs (instead of VVBNs) to find appropriate locations of blocks; in this context, the read path (and corresponding read performance) of a flexible volume is substantially similar to that of a physical volume. Translation from PVBN-to-disk, dbn occurs at the file system/RAID system boundary of the storage operating system 300.

In a dual VBN hybrid flexible volume example, both a PVBN and its corresponding VVBN are inserted in the parent indirect blocks in the buffer tree of a file. That is, the PVBN and VVBN are stored as a pair for each block pointer in most buffer tree structures that have pointers to other blocks, e.g., level 1 (L1) indirect blocks, inode file level 0 (L0) blocks.

A root (top-level) buffer, such as the data section embedded in an inode, references indirect (e.g., level 1) blocks. Note that there may be additional levels of indirect blocks (e.g., level 2, level 3) depending upon the size of the file. The indirect blocks (and inode) include PVBN/VVBN pointer pair structures that ultimately reference data blocks used to store the actual data of the file. The PVBNs reference locations on disks of the aggregate, whereas the VVBNs reference locations within files of the flexible volume. The use of PVBNs as block pointers in the indirect blocks provides efficiencies in the read paths, while the use of VVBN block pointers provides efficient access to required metadata. That is, when freeing a block of a file, the parent indirect block in the file contains readily available VVBN block pointers, which avoids the latency associated with accessing an owner map to perform PVBN-to-VVBN translations; yet, on the read path, the PVBN is available.

### Example Hierarchical Inode Tree

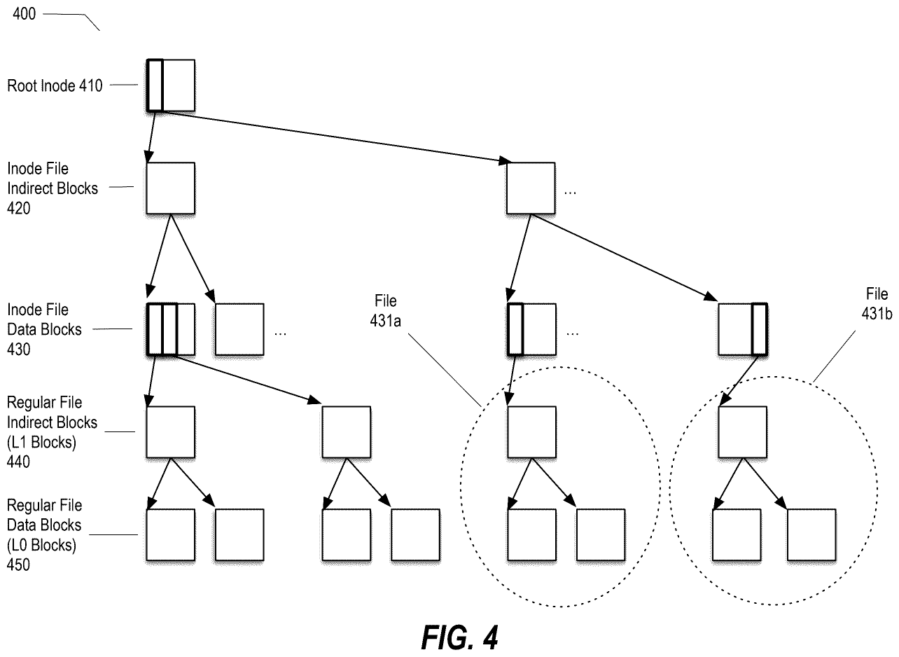

FIG. 4 is a block diagram illustrating a tree of blocks 400 representing a simplified view of an example a file system layout in accordance with an embodiment of the present disclosure. In one embodiment, the data storage system nodes (e.g., data storage systems 110a-b) make use of a write anywhere file system (e.g., the WAFL file system). The write anywhere file system may represent a UNIX compatible file system that is optimized for network file access. In the context of the present example, the write anywhere file system is a block-based file system that represents file system data (e.g., a block map file and an inode map file), metadata files, and data containers (e.g., volumes, subdirectories, and regular files) in a tree of blocks (e.g., tree of blocks 400), which may also be referred to herein as a buffer tree. Keeping metadata in files (which may be referred to herein as metafiles) allows the file system to write metadata blocks anywhere on disk and makes it easier to increase the size of the file system on the fly.

In this simplified example, the tree of blocks 400 has a root inode 410, which describes an inode map file (not shown), made up of inode file indirect blocks 420 and inode file data blocks 430. In this example, the file system uses inodes (e.g., inode file data blocks 430) to describe data containers representing files (e.g., file 431a and file 431b). In one embodiment, each inode contains a predetermined number of block pointers (e.g., 16 block pointers) to indicate which blocks (e.g., of 4 KB) belong to a given data container (e.g., a file). Inodes for data containers smaller than 64 KB may use its block pointers to point to or otherwise identify the location of file data blocks or simply data blocks (e.g., regular file data blocks, which may also be referred to herein as L0 blocks 450). In this example, a given L0 block of L0 blocks 450 corresponds to a block of data on a particular disk. Inodes for files greater than 64 MB may point to indirect blocks (e.g., regular file indirect blocks, which may also be referred to herein as L1 blocks 440), which container pointers to or locations of actual file data on disk. Inodes for larger files or data containers may point to doubly indirect blocks. For very small files, data may be stored in the inode itself in place of the block pointers.

As will be appreciated by those skilled in the art given the above-described file system layout, yet another advantage of DEFSs are their ability to facilitate storage space balancing and/or load balancing. This comes from the fact that the entire global PVBN space of a storage pod is visible to all DEFSs of the cluster and therefore any given DEFS can get access to an entire file by copying the top-most PVBN from the inode to or from another tree.

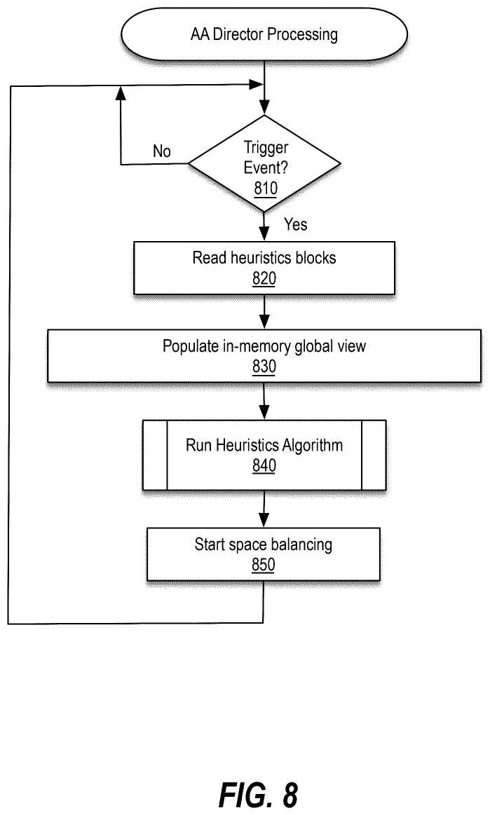

Exemplary optimizations for efficiently transferring metafile data for one or more AAs for which the ownership is being transferred from one DEFS (e.g., a donor DEFS donating the one or more AAs) to another DEFS (e.g., a recipient DEFS receiving the one or more AAs) are described below with reference to FIGS. 8-10B.

### Example of a Distributed Storage System Architecture With Storage Silos

FIG. 5 is a block diagram illustrating a distributed storage system architecture 500 in which the entirety of a given disk and a given RG are owned by an aggregate and the aggregate file system is only visible from one node, thereby resulting in silos of storage space. In the context of FIG. 5, node 510a and node 510b may represent a two-node cluster in which the nodes are high-availability (HA) partners. For example, one node may represent a primary node and the other may represent a secondary node in which pairwise disk connectively supports a pairwise failover model. As shown, each node includes respective active maps (e.g., active map 541a and active map 541b) and a sets of disks (in this case, ten disks) they can talk to. The nodes may partition the disks among themselves as aggregates (e.g., data aggregate 520a and data aggregate 520b) and at steady state both nodes will work on their own subset of disks representing a one or more RGs (in this case, four data disks and one parity disk, forming a single RG). A RAID layer or subsystem (not shown) of a storage operating system (not shown) of each node may present respective separate and independent PVBN spaces (e.g., PVBN space 540a and PVBN space 540b) to a file system layer (not shown) of the node.

In this example, therefore, data aggregate 520a has visibility only to a first PVBN space (e.g., PVBN space 540a) and data aggregate 520b has visibility only to a second PVBN space (e.g., PVBN space 540b). When data is stored to volume 530a or 530b, it is striped across the subset of disks that are part of data aggregate 520a; and when data is stored to volume 530c or 530d, it is are striped across the subset of disks that are part of data aggregate 520b. Active map 541a is a data structure (e.g., a bit map with one bit per PVBN) that that identifies the PVBNs within PVBN space 540a that are in use by data aggregate 520a. Similarly, active map 541b is a data structure (e.g., a bit map with one bit per PVBN) that that identifies the PVBNs within PVBN space 540b that are in use by data aggregate 520b.

As can be seen, for any given disk, the entire disk is owned by a particular aggregate and the aggregate file system is only visible from one node. Similarly, for any given RG, the available storage space of the entire RG is useable only by a single node. There are various other disadvantages to the architecture shown in FIG. 5. For example, moving a volume from one aggregate to another requires copying of data (e.g., reading all the blocks used by the volume and writing them to the new location), with an elaborate handover sequence between the aggregates involved. Additionally, there are scenarios in which one data aggregate may run out of storage space while the other still has plentiful free storage space, resulting in ineffective usage of the storage space provided by the disks. While the size of the PVBN space of an aggregate may be increased, doing so typically requires an administrative user to monitor the storage space on each node-level aggregate and add one or more disks and/or RGs to the aggregate. As described further below with reference to FIG. 6A, with DEFSs storage space is added to a common pool of storage referred to herein as a “storage pod” and space is available for consumption by any DEFS in the cluster, thereby making space management much simpler and facilitating the automatic balancing of storage space without administrator involvement.

### Example Distributed System Architecture Providing Disaggregated Storage

Before getting into the details of a particular example, various properties, constructs, and principles relating to the use and implementation of DEFSs will now be discussed. As noted above, it is desirable to make the global PVBN space of the entire storage pool available on each DEFS of a data pod, which may include one or more clusters. This feature facilitates the performance of, among other things, instant copy-free moves of volumes from one DEFS to another, for example, in connection with performing load balancing. Creating clones on remote nodes for load balancing is yet another benefit. With a global PVBN space, support for global data deduplication can also be supported rather than deduplication being limited to node-level aggregates.

It is also beneficial, in terms of performance, to avoid the use of access control mechanism, such as locks, to coordinate write accesses and write allocation among nodes generally and DEFSs specifically. Such access control mechanisms may be eliminated by specifying, at a per-DEFS level, those portions of the disaggregated storage of the storage pod to which a given DEFS has exclusive write access. For example, as described further below, a DEFS may be limited to use of only the AAs associated with (assigned to or owned by) the DEFS for performing write allocation and write accesses during a CP. Advantageously, given the visibility into the entire global PVBN space, reads can be performed by any DEFS of the cluster from all the PVBNs in the storage pod.

Each DEFS of a given cluster (or data pod, as the case may be) may start at its own super block. As shown and described with reference to FIG. 6A, a predefined AA (e.g., the first AA) in storage pod may be dedicated for super blocks. In one embodiment, a set of RAID stripes within the predefined super block AA (e.g., the first AA of the storage pod) may be dedicated for super blocks. In this predefined super block AA, ownership may be specified at the granularity of a single RAID stripe instead of at the AA granularity of multiple RAID stripes representing one or more GB (e.g., between approximately 1 GB and 10 GB) of storage space. The location of a super block of a given DEFS can be mathematically derived using an identifier (a DEFS ID) associated with the given DEFS. Since the RAID stripe is already reserved for a super block, it can be replicated on N disks.

Each DEFS has AAs associated with it, which may be thought of conceptually as the DEFS owning those AAs. In one embodiment, AAs may be tracked within an AA map and persisted within the DEFS filesystem. An AA map may include the DEFS ID in an AA index. While AA ownership information regarding other DEFSs in the cluster may be cached in the AA map of a given DEFS, which may be useful during the PVBN free path, for example, to facilitate freeing of PVBNs of an AA not owned by the given DEFS (which may arise in situations in which partial AAs are donated from one DEFS to another), the authoritative source information regarding the AAs owned by a given DEFS may be presumed to be in the AA map of the given DEFS.

In support of avoiding storage silos and supporting the more fluid use of disk space across all nodes of a cluster, DEFSs may be allowed to donate partially or completely free AAs to other DEFSs.

Each DEFS may have its own label information kept in the file system. The label information may be kept in the super block or another well-known location outside of the file system.

In various examples, there can be multiple DEFSs on a RAID tree. That is, there may be a many-to-one association between DEFSs and a RAID tree, in which each DEFS may have a reference on the RAID tree. The RAID tree can still have multiple RGs. In various examples described herein, it is assumed the PVBN space provided by the RAID tree is continuous.

It may be helpful to have a root DEFS and a data DEFS that are transparent to other subsystems. These DEFSs may be useful for storing information that might be needed before the file system is brought online. Examples of such information may include controller (node) failover (CFO) and storage failover (SFO) properties/policies. HA is one example of where it might be helpful to bring up a controller (node) failover root DEFS first before giving back the storage failover data DEFSs. HA coordination of bringing down a given DEFS on takeover/giveback may be handled by the file system (e.g., WAFL) since the RAID tree would be up until the node is shutdown.

DEFS data structures (e.g., DEFS bit maps at the PVBN level, such as active maps and reference count (refcount) maps) may be sparse. That is, they may represent the entire global PVBN space but only include valid truth values for PVBNs of AAs that are owned by the particular DEFS with which they are associated. When validation of these bit maps is performed by or on behalf of a particular DEFS, the bits should be validated only for the AA areas owned by the particular DEFS. When using such sparce data structures, to get the complete picture of the PVBN space, the data structures in all of the nodes should be taken into consideration. While various DEFS data structures may be discussed herein as if they were separate metafiles, it is to be appreciated, given the visibility by each node into the entire global PVBN space, one or more of such DEFS data structures may be represented as cluster-wide metafiles. Such a cluster-wide metafile may be persisted in a private inode space that is not accessible to end users and the relevant portions for a particular DEFS may be located based on the DEFS ID of the particular DEFS, for example, which may be associated with the appropriate inode (e.g., an L0 block). Similarly, the entirety of such a cluster-wide metafile may be accessible based on a cluster ID, for example, which may be associated with a higher-level inode in the hierarchy (e.g., an L1 block). In any event, each node should generally have all the information it needs to work independently until and unless it runs out of storage space or meets a predetermined or configurable threshold of a storage space metric (e.g., a free space metric or a used space metric), for example, relative to the other nodes of the cluster. At that point, as described further below, as part of a space monitoring and/or a space balancing process, the node may request a portion of AAs of DEFSs owned by one or more of such other nodes be donated so as to increase the useable storage space of one or more DEFSs of the node at issue.

FIG. 6A is a block diagram illustrating a distributed storage system architecture 600 that provides disaggregated storage in accordance with an embodiment of the present disclosure. Various architectural advantages of the proposed distributed storage system architecture and mechanisms for providing and making use of disaggregated storage include, but are not limited to, the ability to perform automatic space balancing among DEFSs, perform elastic node growth and shrinkage for a cluster, perform elastic storage growth of the storage pod, perform zero-copy file and volume move (migration), perform distributed RAID rebuild, achieve HA cost reduction using volume rehosting, create remote clones, and perform global data deduplication.

In the context of the present example, the nodes (e.g., node 610a and 610b) of a cluster, which may represent a data pod or include multiple data pods, each include respective data dynamically extensible file systems (DEFSs) (e.g., data DEFS 620a and data DEFS 620b) and respective log DEFSs (e.g., log DEFS 625a and log DEFS 625b). In general, data DEFSs may be used for persisting data on behalf of clients (e.g., client 180), whereas log DEFSs may be used to maintain an operation log or journal of certain storage operations within the journaling storage media that have been performed since the last CP.

It should be noted that while for simplicity only two nodes, which may be configured as part of an HA pair for fault tolerance and nondisruptive operations, are shown in the illustrative cluster depicted in FIG. 6A, there may be one or more additional nodes in a given cluster. For example, there may be multiple HA pairs within a cluster (or a data pod of the cluster, which may represent a mechanism to limit the fault domain). As such, the description of this two-node cluster should be taken as illustrative only. Furthermore, while in some examples HA may be achieved by defining pairs of nodes within a cluster as HA partners (e.g., with one node designated as the primary node and the other designated as the secondary), in alternative examples any other node within a cluster may be allowed to step in after a failure of a given node without defining HA pairs.

As discussed above, one or more volumes (e.g., volumes 630a-m and volumes 630n-x) or LUNs (not shown) may be created by or on behalf of customers for hosting/storing their enterprise application data within respective DEFSs (e.g., data DEFSs 620a and 620b).

While additional data structures may be employed, in this example, each DEFS is shown being associated with respective AA maps (indexed by AA ID) and active maps (indexed by PVBN). For example, log DEFS 625a may utilize AA map 627a to track those of the AAs within a global PVBN space 640 of storage pod 645 (which may be analogous to storage pod 145) that are owned by log DEFS 625a and may utilize active map 626a to track at a PVBN level of granularity which of the PVBNs of its AAs are in use; log DEFS 625b may utilize AA map 627b to track those of the AAs within the global PVBN space 640 that are owned by log DEFS 625b and may utilize active map 626b to track at a PVBN level of granularity which of the PVBNs of its AAs are in use; data DEFS 620a may utilize AA map 622a to track those of the AAs within the global PVBN space 640 that are owned by data DEFS 620a and may utilize active map 621a to track at a PVBN level of granularity which of the PVBNs of its AAs are in use; and data DEFS 620b may utilize AA map 622b to track those of the AAs within the global PVBN space 640 that are owned by data DEFS 620b and may utilize active map 621b to track at a PVBN level of granularity which of the PVBNs of its AAs are in use.

In this example, each DEFS of a given node has visibility and accessibility into the entire global PVBN address space 640 and any AA (except for a predefined super block AA 642) within the global PVBN address space 640 may be assigned to any DEFS within the cluster. By extension, each node has visibility and accessibility into the entire global PVBN address space 640 via its DEFSs. As noted above, the respective AA maps of the DEFSs define which PVBNs to which the DEFSs have exclusive write access. AAs within the global PVBN space 640 shaded in light gray, such as AA 641a, can only be written to by node 610a as a result of their ownership by or assignment to data DEFS 620a. Similarly AAs within the global PVBN space 640 shaded in dark gray, such as AA 641b, can only be written to by node 610b as a result of their ownership by or assignment to data DEFS 620b.

Returning to super block 642, it is part of a super block AA (or super AA). In the context of FIG. 6A, the super AA is the first AA of the storage pod 645. The super AA is not assigned to any DEFS (as indicated by its lack of shading). The super AA may have an array of DEFS areas which are dedicated to each DEFS and can be indexed by a DEFS ID. The DEFS ID may start at index 1 and in the context of the present example includes four super block and four DEFS label blocks. The DEFS label can act as a RAID label for the DEFS and can be written out of a CP and can store information that needs to be kept outside of the file system. In a pairwise HA configuration, two super blocks and two DEFS label blocks may be used by the hosting node and the other two may be used by the partner node on takeover. Each of these special blocks may have their own separate stripes.

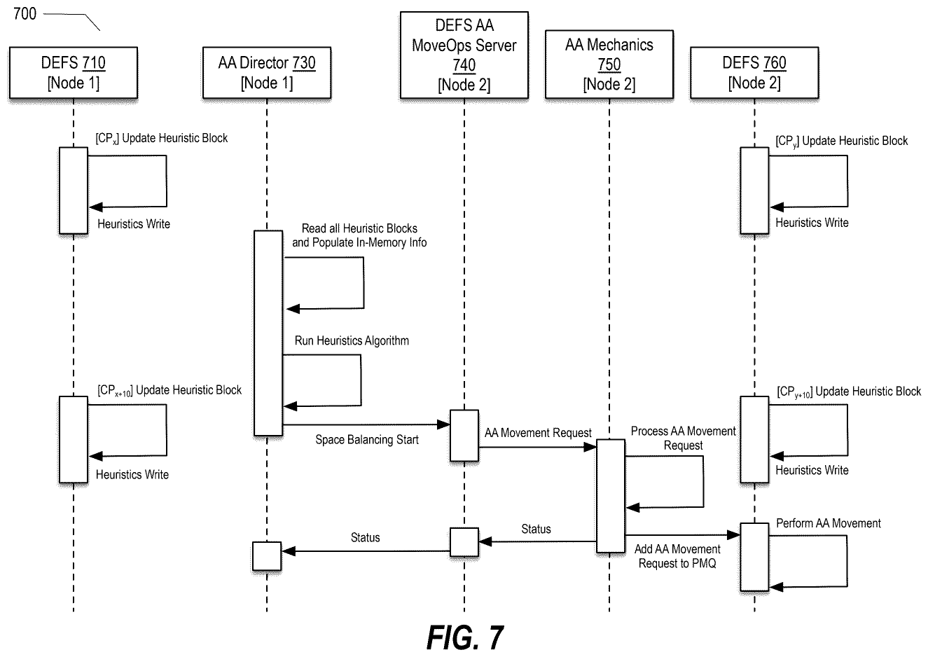

In the context of the present example, it is assumed after establishment of the disaggregated storage within the storage pod 645 and after the original assignment of ownership of AAs to data DEFS 620a and data DEFS 620b, some AAs have been transferred from data DEFS 620a to data DEFS 620b and/or some AAs have been transferred from data DEFS 620b to data DEFS 620a. As such, the different shades of grayscale of entries within the AA maps are intended to represent potential caching that may be performed regarding ownership of AAs owned by other DEFSs in the cluster. For example, assuming ownership of a partial AA has been transferred from data DEFS 620a to data DEFS 620b as part of an ownership change performed in support of space balancing, when data DEFS 620a would like to free a given PVBN (e.g., when the given PVBN is no longer referenced by data DEFS 620a a result of data deletion or otherwise), data DEFS 620a should send a request to free the PVBN to the new owner (in this case, data DEFS 620b). This is due to the fact that in various embodiments, only the current owner of a particular AA is allowed to perform any modify operations on the particular AA. Additional details regarding space balancing (AA movement) and changing of AA ownership is provided below with reference to FIG. 7.

Those skilled in the art will appreciate disaggregation of the storage space as discussed herein can be leveraged for cost-effective scaling of infrastructure. For example, the disaggregated storage allows more applications to share the same underlying storage infrastructure. Given that each DEFS represents an independent file system, the use of multiple of such DEFSs combine to create a cluster-wide distributed file system since all of the DEFSs within a cluster share a global PVBN space (e.g., global PVBN space 640). This provides the unique ability to independently scale each independent DEFS as well as enables fault isolation and repair in a manner different from existing distributed file systems.

Additional aspects of FIG. 6A will now be described in connection with a discussion of FIG. 6B, which represents a high-level flow diagram illustrating operations for establishing disaggregated storage within a storage pod (e.g., storage pod 645). The processing described with reference to FIG. 6B, may be performed by a combination of a file system (e.g., file system 360) and a RAID system (e.g., RAID system 380), for example, during or after an initial boot up.

At block 661, the storage pod is created based on a set of disks made available for use by the cluster. For example, job may be executed by a management plane of the cluster to create the storage pod and assign the disks to the cluster. Depending on the particular implementation and the deployment environment (e.g., on-prem versus cloud), the disks may be associated with of one or more disk arrays or one or more storage shelves or persistent storage in the form of cloud volumes provided by a cloud provider from a pool of storage devices within a cloud environment. For simplicity, cloud volumes may also be referred to herein as “disks.” The disks may be HDDs or SSDs.

At block 662, the storage space of the set of disks may be divided or partitioned into uniform-sized AAs. The set of disks may be grouped to form multiple RGs (e.g., RAID group 650a and 650b) depending on the RAID level (e.g., RAID 4, RAID 5, or other). Multiple RAID stripes may then be grouped to form individual AAs. As noted above, an AA (e.g., AA 641a or AA 641b) may be a large chunk representing one or more GB of storage space and preferably accommodates multiple SSD erase blocks work of data. In one embodiment, the size of the AAs is tuned for the particular file system. The size of the AAs may also take into consideration a desire to reduce the need for performing space balancing so as to minimize the need for internode (e.g., East-West) communications/traffic. In some examples, the size of the AAs may be between about 1 GB to 10 GB. As can be seen in FIG. 6A, dividing the storage pod 645 into AAs allows available storage space associated with any given disk or any RG to be use across many/all nodes in the cluster without creating silos of space in each node. For example, at the granularity of an individual AA, available storage space within the storage pod 645 may be assigned to any given node in the cluster (e.g., by way of the given node's DEFS(s)). For example, in the context of FIG. 6A, AA 641a and the other AAs shaded in light gray are currently assigned to (or owned by) data DEFS 620a (which has a corresponding light gray shading). Similarly, AA 641b and the other AAs shaded in dark gray are currently assigned to (or owned by) data DEFS 620b (which has a corresponding light gray shading).

At block 663, ownership of the AAs is assigned to the DEFSs of the nodes of the cluster. According to one embodiment, an effort may be made to assign group of consecutive AAs to each DEFS. Initially, the distribution of storage space represented by the AAs assigned to each type of DEFS (e.g., data versus log) may be equal or roughly equal. Over time, based on differences in storage consumption by associated workloads, for example, due to differing write patterns, ownership of AAs may be transferred among the DEFSs accordingly.

As a result, of creating and distributing the disaggregated storage across a cluster in this manner, all disks and all RGs can theoretically to be accessed concurrently by all nodes and the issue discussed with reference to FIG. 5 in which the entirety of any given disk and the entirety of any given RG is owned by a single node is avoided.

### Example Sequence Diagram for Space Balancing

FIG. 7 is a sequence diagram 700 illustrating operations performed by various functional units associated with space balancing in accordance with an embodiment of the present disclosure. In the context of the present example, the functional units include a recipient DEFS (e.g., DEFS 710 associated with node 1 of a storage cluster), a donor DEFS (e.g., DEFS 760 associated with node 2 of a storage cluster), an AA director 730, a DEFS AA moveops server 740, and an AA mechanics module 750. DEFS 710 and 760 may be analogous to DEFS 620a and 620b of FIG. 6.

In the context of the present example, all DEFSs (in this case DEFS 710 and DEFS 760) periodically report their respective AA usage information (e.g., total blocks, total used blocks, and for each RG of the DEFS, an RG ID, a disk count, and a histogram representing free space in each AA according to various bins). In one example, the histogram representing free space in each AA according to various bins includes the number of AAs with <5% free space, the number of AAs with 6-25% free space, the number of AAs with 26-50% free space, the number of AAs with 51-75% free space, the number of AAs with 76-95 free space, and the number of AAs with 96-100% free space. According to one embodiment, an AA module (not shown) associated with each DEFS may periodically collect AA usage information for the DEFS at issue and update a heuristic block within the storage pod for the DEFS with such AA usage information, for example, by invoking a heuristics write API call. In one embodiment, the heuristic blocks are located in a well-known location in a DEFS area in RG 0, AA 0 corresponding to the DEFS ID. In this example, DEFS 710 and 760 are shown performing heuristic block updates every 10 CPs. In other examples, the heuristic block updates may be based on or triggered by other events, for example, including time elapsed, CPs, and/or I/O activity.

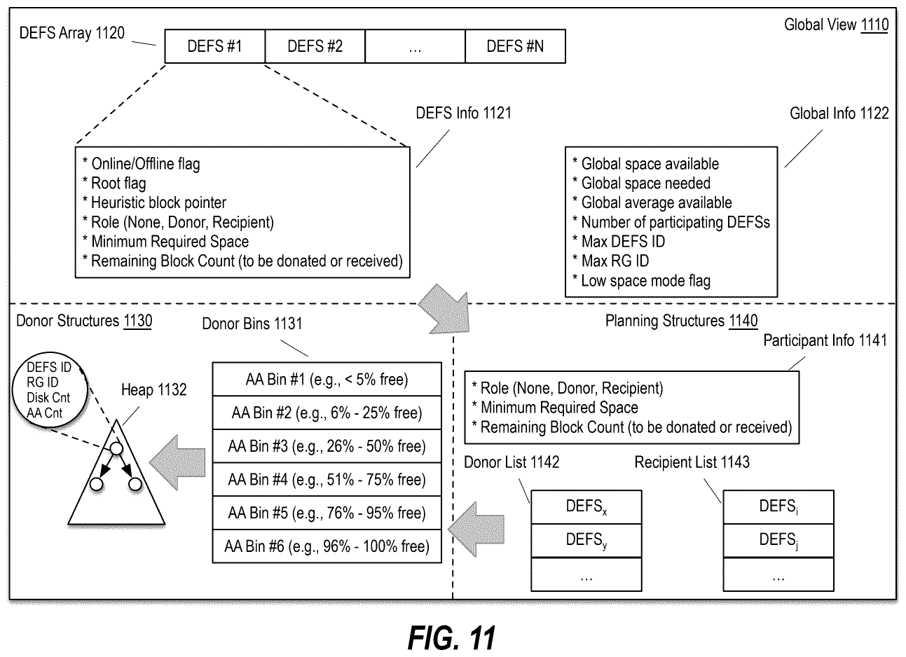

In one embodiment, the AA director 730 represents a centralized module that operates on one node (in this case node 1) of the storage cluster (or, depending on the particular implementation, on one node of each HA pair associated with a given storage pod if there are multiple storage pods). The AA director 730 is responsible for monitoring the AA usage information reported by the DEFSs of the storage cluster and determining when and how many AAs should be moved between one or more identified donor DEFSs and one or more identified recipient DEFSs. In this example, the AA director 730 performs the monitoring by reading all heuristic blocks to which respective DEFSs have persisted their respective AA usage information. Based on the information gathered from the heuristic blocks, the AA director 730 populates in-memory information representing a global view of the system and runs a heuristics algorithm. A non-limiting example of various data structures and information making up the global view is described further below with reference to FIG. 11.

When the heuristics algorithm identifies at least one donor DEFS and one recipient DEFS, the AA director 730 triggers the performance of space balancing, for example, by sending an internode communication or remote procedure call (e.g., a space balancing start message) to the DEFS AA moveops server 740 operable on the same node (in this case, node 2) as the donor DEFS. The space balancing start message may include, among other things, information identifying the donor DEFS (e.g., by its DEFS ID), information identifying the recipient DEFS (e.g., by its DEFS ID), the number of AAs to be donated by the donor DEFS to the recipient DEFS, information identifying the RG (e.g., an RG ID) from which the AAs should be selected, and information regarding the AA quality (e.g., an AA bin or bucket from which the AAs should be selected).

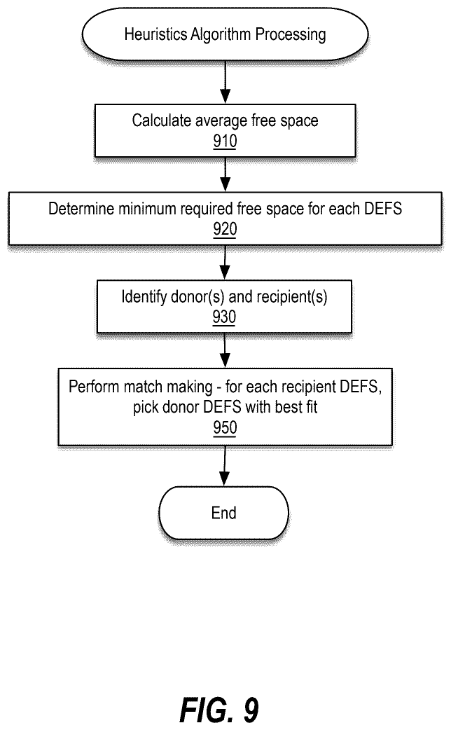

In this example, based on the space balancing start message, the DEFS AA moveops server 740 sends an AA movement request (e.g., including all or a subset of the information contained in the space balancing start message) to the AA mechanics module 750 operable on the same node (in this case, node 2) as the donor DEFS. The AA mechanics module 750 processes the AA movement request, for example, by adding the AA movement request to a persistent message queue (PMQ) of the donor DEFS. Based on the status of the queuing of the AA movement request, success or failure is reported back to the AA director 730 via the DEFS AA moveops server 740. A non-limiting example of a space balancing heuristics algorithm that may be employed in accordance with various embodiments is described further below with reference to FIG. 9. Further details regarding example operation of the AA director 730 are described below with reference to FIG. 8.

In this example, responsive to receiving the AA movement request via its PMQ, the donor DEFS performs AA movement, for example, including selecting AAs for donation to the recipient DEFS based on the AA movement request, initiating the change of ownership of the selected AAs to the recipient DEFS, and moving metafile data for the selected AAs to the recipient DEFS. Further details regarding the mechanics of AA movement are beyond the scope of the present disclosure but are presented in the above-referenced related US Patent Application incorporated by reference herein.

While for simplicity only two DEFSs are shown in the present example, it is to be appreciated each node may have multiple DEFSs. Similarly, while in the present example, only one donor DEFS and one recipient DEFS are shown, it is to be appreciated there may be multiple donor DEFSs and a single recipient DEFS, multiple donor DEFSs and multiple recipient DEFSs, or a single donor DEFS and multiple recipient DEFSs. It is to also be appreciated that there may be no donor DEFSs or recipient DEFSs identified in a particular iteration of the heuristics algorithm, which may be performed on a periodic basis.

### Example AA Director Processing

FIG. 8 is a flow diagram illustrating operations associated with space balancing that may be performed by an AA director in accordance with an embodiment of the present disclosure. The processing described with reference to FIG. 8 may be performed by an AA director (e.g., AA director 730 of FIG. 7).

At decision block 810, it is determined whether a trigger event (e.g., expiration of a timer) has occurred. If so, processing continues with block 820; otherwise, processing loops back to decision block 810. In one embodiment, AA director processing is performed periodically (e.g., every 3 minutes or every 1 minute) with the timing depending on whether the storage cluster is operating under normal operating conditions or whether the storage cluster is operating in low space mode. According to one embodiment, when the total free space across all DEFSs of the storage cluster is less than a predetermined or configurable low space threshold (e.g., 10%) of total blocks, then the storage cluster is operating in low space mode. In other examples, the storage cluster may be said to be operating in low space mode when free storage space available to all DEFSs via their respectively owned AAs is below their respective minimum required amount of free space (which may be a predetermined or configurable static value or a dynamically determined value based on an observed fill rate of the storage space available to a given DEFS and/or incoming Input/Output (I/O) rate and reserve space needed by the given DEFS).

At block 820, the AA director reads the heuristics blocks of all DEFSs of the storage cluster. For example, the AA director may loop through all DEFS IDs and invoke a heuristics read API call to retrieve the AA usage information last reported (persisted) by each DEFS.

At block 830, the AA director populates an in-memory global view. For example, based on the reading of the heuristics blocks in block 820, the AA director may aggregate the collected information and/or calculate or determine one or more storage space metrics (e.g., average free space across all DEFSs and minimum required free space for each DEFS) to provide a system wide view upon which a space balancing heuristics algorithm may operate. A non-limiting example of various data structures and information making up the global view is described further below with reference to FIG. 11.

At block 840, after the in-memory global view has been built, the space balancing heuristics algorithm is run with reference to the in-memory global view. For example, in one embodiment, the heuristics algorithm is responsible for determining the existence of a set of one or more donor DEFSs and a set of one or more recipient DEFSs at a given point in time, and triggering AA movement accordingly by matching one or more donor DEFSs to each recipient DEFS. A non-limiting example of a space balancing heuristics algorithm that may be employed in accordance with various embodiments is described below with reference to FIG. 9.

At block 850, assuming the heuristics algorithm has identified at least one donor DEFS and at least one recipient DEFS during the current iteration, the AA director initiates the performance of space balancing, for example, by sending a space balancing start request/message to a DEFS AA moveops server (e.g., DEFS AA moveops server 740) as shown in FIG. 7.

### Example Space Balancing Heuristic Algorithm

FIG. 9 is a flow diagram illustrating operations for performing a space balancing heuristic algorithm in accordance with an embodiment of the present disclosure. The processing described with reference to FIG. 9 may be performed by an AA director (e.g., AA director 730 of FIG. 7), for example, as part of block 840 of FIG. 8.

At block 910, average free space is calculated. According to one embodiment, the total free space available to all DEFSs that are available/eligible (e.g., those that are online) to participate in space balancing is first calculated. Then, the total free space is divided by the total number of DEFSs that are available/eligible to participate in space balancing. In one embodiment, log (or root DEFSs) do not participate in space balancing-only data DEFSs that are online at the time.

At block 920, the minimum required free space is determined for each participating DEFS. For example, the minimum required free space may be a predetermined or configurable static value or may be determined dynamically. In one embodiment, the minimum required free space for a given DEFS may be determined based on the incoming I/O rate.

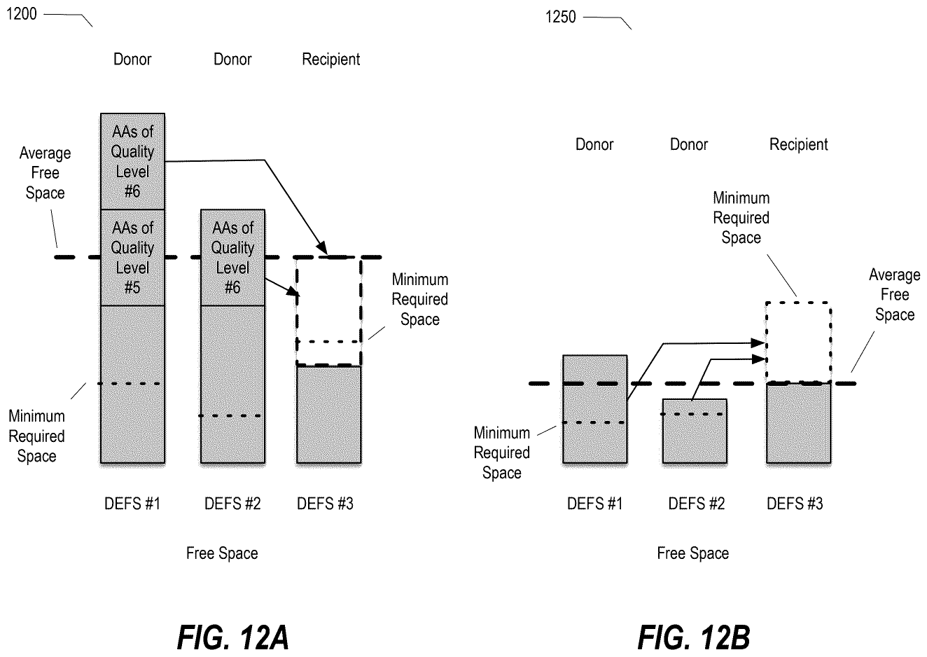

At block 930, a set of zero or more donor DEFSs and a set of zero or more recipient DEFSs are identified. Depending on the particular embodiment, one or both of the minimum required free space, the average free space, and the average free space delta of a given DEFS may be used to identify the given DEFS as a donor DEFS, a recipient DEFS, or neither. For example, as described further below with reference to FIG. 12A, when operating in normal mode (not low space mode), in an effort to avoid/minimize potential thrashing, in order to be identified as a recipient DEFS, a given DEFS may be required to have free space greater than or equal to a predetermined or configurable minimum delta (e.g., 20%) below the average free space calculated in block 910. In normal mode of operation, to qualify as a donor DEFS, a given DEFS may need to have free space greater than the average free space.

Alternatively, as described further below with reference to FIG. 12B, when operating in low space mode, in order to avoid running out of space on a given DEFS prematurely, the average free space metric may no longer be taken into consideration. Instead, any DEFS having less than its respective minimum required space may qualify as a recipient DEFS regardless of the DEFS′ free space delta from the average free space. Additionally, in low space mode, any DEFS having greater than its minimum required space may be considered a donor DEFS and all donor DEFSs may give out as much space as possible (e.g., only reserving their respective minimum required space).

At block 940, assuming at least one donor DEFS and at least one recipient DEFS was identified in block 930, match making is performed to identify for each recipient DEFS one or more donor DEFSs that best fit the storage space needs of the recipient DEFS. A non-limiting example, of an exemplary approach for performing this match making is described further below with reference to FIG. 11.

While in the context of the flow diagrams of FIGS. 6B, 8, and 9 a number of enumerated blocks are included, it is to be understood that examples may include additional blocks before, after, and/or in between the enumerated blocks. Similarly, in some examples, one or more of the enumerated blocks may be omitted and/or performed in a different order.

### Example HA Cluster and AA Heuristic Data Maintained by Nodes and AA Director

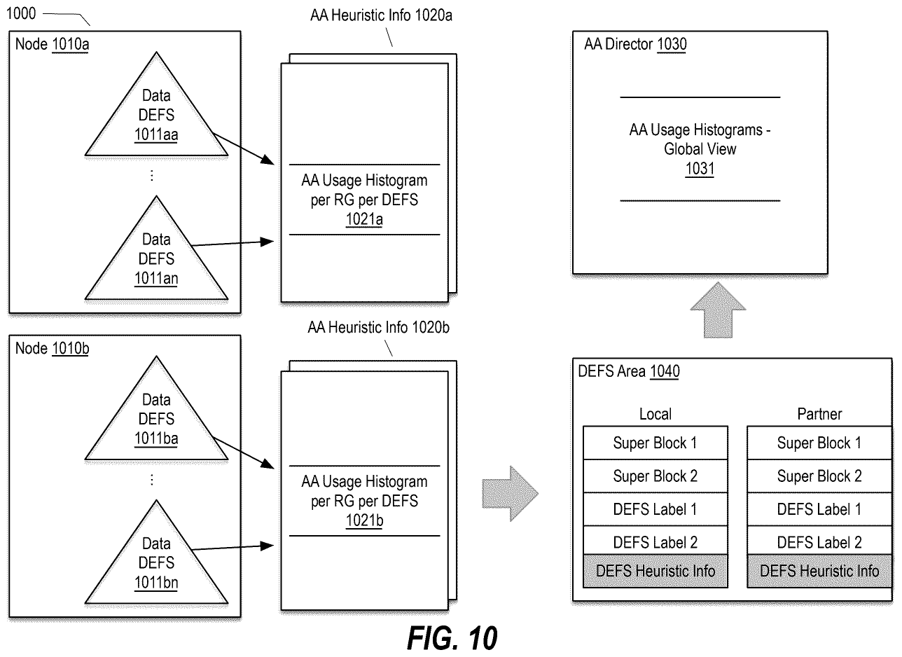

FIG. 10 is a block diagram conceptually illustrating nodes of a high-availability (HA) cluster (comprising nodes 1010a and 1010b) and relevant AA heuristic data maintained by the respective nodes and an AA director 1030 in accordance with an embodiment of the present disclosure. Nodes 1010a and 1010b may be analogous to nodes 110a and 110b and/or nodes 610a and 610b. AA director 1030 may be analogous to AA director 730.

In the context of the present example, each node is shown having respective data DEFSs (e.g., data DEFSs 1011aa-an and data DEFSs 1011ba-bn), which may be analogous to data DEFSs 620a and 620b. The data DEFSs or respective AA modules (not shown) associated therewith maintain AA heuristic info (e.g., AA heuristic info 1020a and 1020b), which includes AA usage histograms per RG per DEFS (e.g., AA usage histogram per RG per DEFS 1021a and 1021b).

The AA usage histogram per RG per DEFS may include the number of AAs for a given RG and a given DEFS that are associated with a particular AA quality level, bucket, or bin. In one embodiment, for example, as described with reference to FIG. 7, the number of AAs associated with six different bins (e.g., (i) AAs having <5% free space, (ii) AAs having 6-25% free space, (ii) AAs having 26-50% free space, (iv) AAs having 51-75% free space, (v) AAs having 76-95 free space, and (vi) AAs having 96-100% free space) may be tracked by a given AA usage histogram per RG per DEFS. In other examples, there may be more of fewer bins and the percent free ranges may differ. For example, in one embodiment, AAs having 100% free space may be separated from the bin of AA having 96-99% free space. In another example, AA having 0% free space may be separated from the bin of AAs having <5% free space. Additionally, the nature of the bins may also differ based on the heuristic policies used. For example, in other embodiments, the bins may track used space rather than free space as a measure of AA quality.

Additional information that may be maintained as part of the AA heuristic information includes but is not limited to the total number of owned blocks for a given DEFS, the total number of used blocks for a given DEFS, the number of RGs in a given DEFS, the number of disk in a given RG, and/or the like.

On a periodic basis and/or responsive to predetermined or configurable system events, the data DEFSs or respective AA modules (not shown) associated therewith may persist their AA heuristic information to respective DEFS heuristic blocks or DEFS heuristic info (shown with a gray background) within a well-known DEFS area 1040 within the storage pod. In one embodiment, the DEFS heuristic info for each DEFS is maintained in a single data block (e.g., 4 KB) on persistent storage and resides next to a local copy of the DEFS label(s).

On a periodic basis and/or responsive to predetermined or configurable system events, the AA director 1030 may read the DEFS heuristic info from the DEFS area 1040 and populate an in-memory global view (e.g., AA usage histograms-global view 1031). A non-limiting example of this in-memory global view is described below with reference to FIG. 11.

### Example Global View for Performance of Space Balancing Heuristics

FIG. 11 is a block diagram conceptually illustrating a global view 1110 of system information used to perform space balancing heuristics in accordance with an embodiment of the present disclosure. In this example, the global view 1110 includes a DEFS array 1120 and global info 1122. The DEFS array 1120 may include DEFS info 1121 for each DEFS within the storage cluster. As noted above, the DEFS info 1121 may be populated by looping through all the DEFS IDs associated with the storage cluster and accessing the corresponding DEFS label and/or DEFS heuristics block, as appropriate, for example, via respective read APIs.

According to one embodiment, the DEFS info 1121 is populated during a first iteration over the respective on-disk DEFS heuristics blocks. The DEFS info 1121 will in turn be used to determine which DEFSs will represent donor DEFSs and will donate AAs and which will represent recipient DEFSs and will receive AAs, if any, during performance of a subsequent space balancing. During this first iteration, a copy of each of the DEFS heuristics blocks may be stored in memory and a pointer to the buffer may be saved in the DEFS info 1121 for future reference. In this example, the DEFS info 1121 is shown including an online/offline flag indicating whether the DEFS at issue is online (and available to participate in space balancing at this time) or offline (and unavailable to participate in space balancing at this time), a root flag (e.g., indicating the DEFS represents a log DEFS), a heuristic block (or buffer) pointer to the in-memory copy of the corresponding DEFS heuristics block, a role field indicative of the role (e.g., none, donor, or recipient) the DEFS will play in any subsequently performed space balancing, an indication regarding the minimum required space needed by the DEFS, and a remaining block count (e.g., for tracking the number of remaining blocks to be donated by a donor or the number of remaining blocks to be received by a recipient during space balancing).

In one embodiment, certain calculated information is computed during the initial walk of the on-disk DEFS heuristics blocks and stored in a separate global info structure (e.g., the global info 1122). In this example, the global info 1122 is shown including information regarding (i) the total amount of global storage space available (e.g., the aggregate of all storage space available to all DEFSs via their respective AAs), (ii) the total amount of global storage space needed (e.g., the aggregate of all DEFS storage space needs, for example, to meet their respective minimum space needs or bring them to the average free space, as appropriate), (iii) the total amount of global storage space available (e.g., the aggregate of all DEFS available storage space, for example, in excess of the average free space or in excess of their respective minimum space needs, as appropriate), (iv) the number of participating DEFSs (e.g., excluding those DEFSs that are offline and/or those representing root (or log) DEFSs), (v) the maximum DEFS ID, (vi) the maximum RG ID, and (vii) a low space mode flag indicative of whether the storage cluster is operating in low space mode during this iteration of the space balancing heuristics algorithm.

Additional data structures that may be populated during or before performance of space balancing heuristics include one or more donor structures 1130 and one or more planning structures 1140. In this example, the planning structures 1140 are shown including participant info 1141, a donor list 1142, and a recipient list 1143. The participant info 1141 may be populated based on the DEFS info 1121 for only those DEFSs (i.e., recipient DEFSs and donor DEFSs) that will be participating in the subsequent space balancing. The participant info 1141 may include information regarding (i) the role of a given DEFS, (ii) the minimum required space by the given DEFS, and (iii) a remaining block count (representing a number of blocks remaining to be donated by donors or a number of blocks remaining to be received for recipients). The donor list 1142 may represent a linked list of those participating DEFSs identified as donor DEFSs (e.g., based on their respective excess available free space over and above the average available free space or based on their respective minimum required space, as appropriate). The recipient list 1143 may represent a linked list of those participating DEFSs identified as recipient DEFSs based on their respective storage space needs (e.g., in terms of a percentage delta below the average available free space or in terms of being below their respective minimum required space, as appropriate).

In one embodiment, the donor structures 1130 are dependent upon information (e.g., the AA usage information, such as the AA histogram per RG per DEFS) stored within the in-memory copies of the DEFS heuristics blocks and are populated after performance of an initial walk through the on-disk DEFS heuristics blocks and population of the participant info 1141, donor list 1142, and recipient list 1143. In this manner, efficiencies can be achieved by avoiding populating data structures for non-donor DEFSs and waiting until it is known that there is at least one recipient DEFS.

After the donor list 1142 and the recipient list 1143 have been populated, the full requirements of who the donors are, how much they can donate, and who the recipients are along with their respective block counts to address their respective storage space deficiencies. At this point, the donor structures 1130 may be populated. During population of the donor structures 1130, for each donor DEFS, the donor structures 1130 need only be populated up to the donor DEFSs remaining block count. For example, as the donor bins 1131 are populated for a particular donor DEFS based on its AAs available for donation, its remaining block count can be decremented and use of AAs from that particular donor DEFS may stop once the remaining block count is zero. In order to convert from AAs to blocks, a conservative approach may be used for donors and recipients by using the lower bin or bucket percentage for donors and the upper bin or bucket percentage for recipients. For example, an AA that is in the 96-100% bin may be assumed to be 100% full for donor block count updates and may be assumed to be 96% full for recipient block count updates.

In this example, the donor structures 1130 include donor bins 1131 and heaps for each bin (e.g., heap 1132). The donor bins 1131 include a number of AAs (across all donor DEFSs in the donor list 1142) that are associated with each bin (e.g., AAs having <5% free space, etc.). For each bin, a heap (e.g., heap 1132) may be created to prioritize the selection of AAs for use by recipient DEFSs. In one embodiment, a heap score may be computed for each set of AAs available to be donated that are associated with a particular bin based on the number of AAs (AA_cnt) and the number of disks (disk_cnt) associated with the RG at issue. For example, the heap 1132 may be a max-heap data structure that keeps the AAs with the maximum heap score (e.g., AA_cnt*disk_cnt) on top. In this manner, the largest group of AAs will always be located at the top of a given heap. In this example, each node of the heap includes the DEFS ID from which the AAs are available, the RG ID in which the AAs are located, the disk count, and the AA count (representing the number of AAs available for donation by this DEFS in this RG).

After the donor structures 1130 have been built, a match-making algorithm may be used to satisfy the requirements of the recipient DEFSs by, for example, iterating through each recipient DEFS, and searching the donor bins 1131 for available AAs to meet the recipient's needs (e.g., starting at the best quality and moving to the next best quality as necessary when bins become empty). As a set of one or more AAs is found in the donor bins 1131, the match-making algorithm may pull a node from the top of the corresponding heap, reduce the bin count accordingly, and decrement the remaining block count each iteration.

In one example, a fairness mechanism may be implemented to allow all recipient DEFSs a reasonable opportunity to be matched with high-quality AAs. For example, a predetermined or configurable maximum number of AAs per iteration (per match for a given recipient DEFS) may limit the number of AAs allowed to be claimed in a given iteration. Additionally, in one example, the recipient list 1143 may be sorted to prioritize the recipient DEFSs in order of their respective needs for storage space. In one embodiment, upon the completion of each iteration, the heaps may be re-heapified as appropriate, and the recipient list 1143 may be resorted. Notably, this may result in the same recipient DEFS being matched with AAs in multiple consecutive iterations is that recipient DEFS remains the recipient DEFS having the greatest storage space need after having been matched with one or more sets of AAs in a prior iteration.

In one example, the match-making algorithm may output a linked list in which each element of the linked list identifies (i) the donor DEFS ID, (ii) the recipient DEFS ID, (iii) the donor RG ID, (iv) the AA quality, (v) the AA count, (vi) the disk count, and (vii) a next element pointer. As AA matches are found, the match-making algorithm may add elements to the list.

Notably, as in some examples, the storage space needs of recipient DEFSs is expressed in terms of a number of blocks (e.g., of size 4 KB) and the size of AAs is measured in GB, there is a granularity disconnect. It would be inefficient, for example, for the match-making algorithm to claim a set of AAs representing 200 GB of storage space when the recipient's remaining block count is 100. According to one embodiment, an over donation check may be performed during the match-making algorithm to preclude claiming a donated set of AAs that represents N (e.g., 2 or 3) times more storage space than the remaining block count of the recipient DEFS at issue. When an over donation is detected, the match-making algorithm may skip over the top of the heap and look for a smaller set of AAs in the heap.

### Example Free Space Graphs

FIG. 12A is a free space graph 1200 conceptually illustrating how space balancing operates during a normal mode in accordance an embodiment of the present disclosure. In the normal mode of operation, the storage cluster has sufficient free space and there is no urgency to perform space balancing. In one embodiment, the goal in this mode of operation is to balance the free space among the DEFSs and bring each DEFS toward the average free space. In the context of the present example, two donor DEFSs (i.e., DEFS #1 and #2) and one recipient DEFS (i.e., DEFS #3) is assumed to have been identified by the space balancing heuristics algorithm (e.g., the space balancing heuristics algorithm of FIG. 9). In this example, free space is shown with a gray background and a storage space deficiency is shown with a white background. Because there is no urgency in this mode of operation, the AA director should move AAs only if free space is too far out of balance, for example, as indicated by one or more DEFSs being greater than a predetermined or configurable delta (e.g., 20%) below the average free space. In this example:
The AA director (e.g., AA director 730 or 1030) will try to give out the best AA(s) from both DEFS #1 and #2 to bring the free space of DEFS #3 closer to the average free space.
The AA director will select AAs available for donation from DEFS #1 and #2 for receipt by DEFS #3 until the free space of DEFS #3 reaches the average free space.
DEFS #3 will receive AAs representing storage space that will take its free space beyond its minimum required space and potentially all the way to the average free space.

FIG. 12B is a free space graph conceptually illustrating how space balancing operates during a low space mode in accordance an embodiment of the present disclosure. In the low space mode of operation, the storage cluster is running low on storage space. In one embodiment, the goal in this mode of operation is to make all efforts not to run out of space prematurely on a particular DEFS. In this mode of operation, the average free space metric is no longer a consideration. Instead all donor DEFSs, are expected to give out as much storage space as possible (e.g., only reserving enough (e.g., the minimum required space) so that the recipient DEFS(s) can stay above their respective minimum required space. In this mode, AA quality is generally expected to be bad in terms of free-space availability. As a result, it is likely that more AAs will have to be moved in this mode of operation.

In this example (as above), two donor DEFSs (i.e., DEFS #1 and #2) and one recipient DEFS (i.e., DEFS #3) is assumed to have been identified by the space balancing heuristics algorithm (e.g., the space balancing heuristics algorithm of FIG. 9). In this example, free space is again shown with a gray background and a storage space deficiency is shown with a white background. Because there is more urgency in this mode of operation, the AA director should perform the space balancing heuristics algorithm more frequently. For example, in the normal mode of operation, the time interval may be on the order of 3 minutes or so, whereas in low space mode, the time interval may be reduced to on the order of 1 minute or so. In this example:
DEFS #1 will donate until it reaches its minimum required space assuming DEFS #3 needs this space to reach its minimum required space.
DEFS #2 will donate even it if will end up with less than a desired amount of free space (e.g., less than the average free space).
If all DEFSs go below their respective minimum required space, the AA director should stop performing space balancing as no amount of AA movement can resolve this issue. At this point, or preferably before the storage cluster reaches this point, an administrator of the storage cluster should be alerted to add disks to the storage pod.

Various alternatives are contemplated. For example, in one embodiment, the minimum required space parameter may not be used during the space balancing heuristic algorithm or when identifying AAs that may be donated by donor DEFSs when the storage system is operating in low space mode. Instead, each DEFS may simply keep in reserve and not report as available for donation a predetermined or configurable or dynamically calculated number of “reserve” AAs. In one example, the number of “reserve” AAs may ultimately correspond to the minimum required space for a given DEFS; however, by using the notion of “reserve” AAs, the concept of a minimum required space is internalized rather than being exposed to the space balancing heuristic algorithm. In an example in which the minimum required space parameter is not implemented, during the low space mode of operation, the threshold for qualifying as a recipient DEFS may be the DEFS at issue having below the average free space without reference to a threshold.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors (e.g., processors 222a-b) within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device (e.g., local storage 230). Volatile media includes dynamic memory, such as main memory (e.g., memory 224). Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (e.g., system bus 223). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory (e.g., memory 224), from which the one or more processors retrieve and execute the instructions. The instructions received by main memory may optionally be stored on storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method comprising:
providing a storage pod having a group of storage devices containing a plurality of Redundant Array of Independent Disks (RAID) groups, wherein an entirety of a global physical volume block number (PVBN) space associated with the storage pod is accessible to each node of a plurality of nodes of a cluster representing a distributed storage system via their respective file systems and wherein storage space associated with the group of storage devices is partitioned into a plurality of allocation areas (AAs), in which a given AA of the plurality of AAs is owned by a given file system of a plurality of file systems of the cluster;
determining one or more storage space metrics based on usage information relating to the plurality of AAs reported by or on behalf of their respective owning file systems of the plurality of file systems;
identifying a set of multiple donor file systems and a set of multiple recipient file systems from among the plurality of file systems based on the usage information; and
facilitating space balancing by matching at least one donor file system of the set of multiple donor file systems with a particular recipient file system of the set of multiple recipient file systems, wherein the matching includes iterating through each recipient file system of the set of multiple recipient file systems in order of decreasing storage space needs of the recipient file system and identifying one or more AAs that meet the storage space needs of the recipient file system from AAs available for donation from the set of multiple donor file systems.

2. The method of claim 1, wherein the one or more storage space metrics includes an average amount of free space available to a subset of the plurality of file systems, that participate in the space balancing, via their respectively owned AAs of the plurality of AAs.

3. The method of claim 2, wherein a file system of the plurality of file systems qualifies for inclusion in the set of multiple recipient file systems based on an amount of free space available to the file system, via those of the AAs of the plurality of AAs owned by the file system, being greater than or equal to a predetermined or configurable threshold below the average amount of free space available.

4. The method of claim 1, wherein the one or more storage space metrics includes a minimum required amount of free space by each of a subset of the plurality of file systems that participate in the space balancing.

5. The method of claim 4, wherein a file system of the plurality of file systems qualifies for inclusion in the set of multiple recipient file systems based on an amount of free space available to the file system via those of the AAs of the plurality of AAs owned by the file system being less than the minimum required amount of free space by the file system.

6. The method of claim 1, wherein said determining and identifying are performed periodically in accordance with a predetermined or configurable time.

7. The method of claim 6, wherein the predetermined or configurable time is reduced based on the distributed storage system operating in a low space mode.

8. A non-transitory machine readable medium storing instructions, which when executed by one or more processing resources of a distributed storage system, cause the distributed storage system to:
provide a storage pod having a group of disks containing a plurality of Redundant Array of Independent Disks (RAID) groups, wherein an entirety of a global physical volume block number (PVBN) space associated with the storage pod is accessible to all nodes of a plurality of nodes of a cluster representing the distributed storage system via their respective dynamically extensible file systems (DEFSs) and wherein storage space associated with the group of storage devices is partitioned into a plurality of allocation areas (AAs), in which a given AA of the plurality of AAs is owned by a given DEFS of a plurality of DEFSs of the cluster;
determine one or more storage space metrics based on usage information relating to the plurality of AAs reported by or on behalf of their respective owning DEFSs of the plurality of DEFSs;
identify a set of multiple donor DEFSs and a set of multiple recipient DEFSs from among the plurality of DEFSs based on the usage information; and
facilitate space balancing by matching at least one donor DEFS of the set of multiple donor DEFSs with a recipient DEFS of the set of multiple recipient DEFSs, wherein the matching includes iterating through each recipient DEFS of the set of multiple recipient DEFSs in order of decreasing storage space needs of the recipient DEFS and identifying one or more AAs that meet the storage space needs of the recipient DEFS from AAs available for donation from the set of multiple donor DEFSs.

9. The non-transitory machine readable medium of claim 8, wherein the one or more storage space metrics includes an average amount of free space available to a subset of the plurality of DEFSs, that participate in the space balancing, via their respectively owned AAs of the plurality of AAs.

10. The non-transitory machine readable medium of claim 9, wherein a DEFS of the plurality of DEFSs qualifies for inclusion in the set of multiple recipient DEFSs based on an amount of free space available to the DEFS, via those of the AAs of the plurality of AAs owned by the DEFS, being greater than or equal to a predetermined or configurable threshold below the average amount of free space available.

11. The non-transitory machine readable medium of claim 8, wherein the one or more storage space metrics includes a minimum required amount of free space by each of a subset of the plurality of DEFSs that participate in the space balancing.

12. The non-transitory machine readable medium of claim 11, wherein a DEFS of the plurality of DEFSs qualifies for inclusion in the set of multiple recipient DEFSs based on an amount of free space available to the DEFS via those of the AAs of the plurality of AAs owned by the DEFS being less than the minimum required amount of free space by the DEFS.

13. The non-transitory machine readable medium of claim 8, wherein determination of one or more storage space metrics and identification of the set of multiple donor DEFSs and the set of one or more recipient DEFSs are performed periodically in accordance with a predetermined or configurable time.

14. The non-transitory machine readable medium of claim 13, wherein the predetermined or configurable time is reduced based on the distributed storage system operating in a low space mode.

15. A distributed storage system comprising:
one or more hardware processing resources; and
instructions that when executed by the one or more hardware processing resources cause the distributed storage system to:
provide a storage pod having a group of storage devices containing a plurality of Redundant Array of Independent Disks (RAID) groups, wherein an entirety of a global physical volume block number (PVBN) space associated with the storage pod is accessible to all nodes of a plurality of nodes of a cluster representing the distributed storage system via their respective dynamically extensible file systems (DEFSs) and wherein storage space associated with the group of storage devices is partitioned into a plurality of allocation areas (AAs), in which a given AA of the plurality of AAs is owned by a given DEFS of a plurality of DEFSs of the cluster;
determine one or more storage space metrics based on usage information relating to the plurality of AAs reported by or on behalf of their respective owning DEFSs of the plurality of DEFSs;
identify a set of multiple donor DEFSs and a set of multiple recipient DEFSs from among the plurality of DEFSs based on the usage information; and
facilitate space balancing by matching at least one donor DEFS of the set of multiple donor DEFSs with a recipient DEFS of the set of multiple recipient DEFSs, wherein the matching includes iterating through each recipient DEFS of the set of multiple recipient DEFSs in order of decreasing storage space needs of the recipient DEFS and identifying one or more AAs that meet the storage space needs of the recipient DEFS from AAs available for donation from the set of multiple donor DEFSs.

16. The distributed storage system of claim 15, wherein the one or more storage space metrics includes an average amount of free space available to a subset of the plurality of DEFSs, that participate in the space balancing, via their respectively owned AAs of the plurality of AAs.

17. The distributed storage system of claim 16, wherein a DEFS of the plurality of DEFSs qualifies for inclusion in the set of multiple recipient DEFSs based on an amount of free space available to the DEFS, via those of the AAs of the plurality of AAs owned by the DEFS, being greater than or equal to a predetermined or configurable threshold below the average amount of free space available.

18. The distributed storage system of claim 15, wherein the one or more storage space metrics includes a minimum required amount of free space by each of a subset of the plurality of DEFSs that participate in the space balancing.

19. The distributed storage system of claim 18, wherein a DEFS of the plurality of DEFSs qualifies for inclusion in the set of multiple recipient DEFSs based on an amount of free space available to the DEFS via those of the AAs of the plurality of AAs owned by the DEFS being less than the minimum required amount of free space by the DEFS.

20. The distributed storage system of claim 15, wherein determination of one or more storage space metrics and identification of the set of multiple donor DEFSs and the set of multiple recipient DEFSs are performed periodically in accordance with a predetermined or configurable time.

21. The distributed storage system of claim 15, wherein the predetermined or configurable time is reduced based on the distributed storage system operating in a low space mode.

22. The distributed storage system of claim 15, wherein the usage information is reported by storing the usage information within corresponding on-disk heuristic blocks within the storage pod.

23. The distributed storage system of claim 15, wherein the usage information includes an AA usage histogram indicative of a number of AAs categorized into a given quality bin of multiple AA quality bins.

24. The method of claim 1, wherein the usage information is reported by storing the usage information within corresponding on-disk heuristic blocks within the storage pod.

25. The method of claim 1, wherein the usage information includes an AA usage histogram indicative of a number of AAs categorized into a given quality bin of multiple AA quality bins.

26. The non-transitory machine readable medium of claim 8, wherein the usage information is reported by storing the usage information within corresponding on-disk heuristic blocks within the storage pod.

27. The non-transitory machine readable medium of claim 8, wherein the usage information includes an AA usage histogram indicative of a number of AAs categorized into a given quality bin of multiple AA quality bins.
